(19) United States
(12) Patent Application Publication
(10) Pub. No.: US 2006/0167926 A1
(43) Pub. Date: Jul. 27, 2006

(54) Vineyard information collection and management system

(76) Inventors: James Verhey, Napa, CA (US); Alfred Buckland, Garden Valley, CA (US); Steve Matthiason, Napa, CA (US); John Duckhorn, Folsom, CA (US)

Correspondence Address: MCCARTER & ENGLISH, LLP, FOUR GATEWAY CENTER, 100 MULBERRY STREET, NEWARK, NJ, 07102, US

(21) Appl. No.: 11/044,654

(22) Filed: Jan. 27, 2005

(51) Int. Cl. G06F 17/00; G06F 7/00

(52) U.S. Cl. 707/102

(57) ABSTRACT

A vineyard information collection and management system is provided. The system allows a variety of information at one or more vineyards to be collected in real time, processed at a central server, and provided to users over the Internet using customizable, easy-to-use forms and pages accessible using a conventional web browser. The system includes planning, analysis, and management tools that assist in making purchasing, operations, and management decisions at one or more vineyards. The invention includes a plurality of software modules that provide useful, real-time information about vineyards.

### BACKGROUND OF THE INVENTION

1. Field of the Invention

The present invention relates to an information collection and management system accessible through the Internet. More particularly, the present invention relates to an information collection, management, analysis, and reporting system for use in collecting, managing, analyzing and reporting vineyard information.

2. Related Art

Various data management systems have in the past been developed for allowing agricultural data to be remotely monitored and accessed over an information network. Such systems allow conditions at an agricultural location to be remotely monitored, and data from one or more locations stored in a computer system accessible via a communications network. Further, systems have in the past been developed for allowing irrigation and chemical delivery at a vineyard to be remotely monitored using a computer system and one or more sensors at the vineyard. Additionally, some remote monitoring systems allow photos, videos and other types of information about a vineyard to be accessed from a website.

A particular problem with existing data management systems is that they capture only limited types of data at a vineyard, thereby limiting the usefulness of such systems as vineyard planning and management tools. As such, these systems do not capture robust types of information in real time at a vineyard, including, but not limited to, imagery, weather data, viticultural analysis, farm plans, pest information, canopy information, operational management information, harvest chemistry, and other types of measurable information and remotely sensible parameters. Further, existing systems fail to provide analysis, planning, and management tools that include features useful in making purchasing, management, and operations decisions at one or more vineyards, and which track and analyze information such as crop yield prediction, viticultural alerts, water status, pest status, nutrient status, weather information, grape maturity tracking, operational schedules and timelines, and other useful information.

Accordingly, what would be desirable, but has not yet been provided, is a vineyard information collection and management system that allows for a variety of information to be collected, either directly or from third party vendors/consultants, in real time at one or more vineyards, processed, and presented to users over the Internet using easy-to-use forms and pages, and which provides analysis, planning, and management tools to assist in making purchasing, management, and operations decisions at a vineyard.

### SUMMARY OF THE INVENTION

The present invention provides a vineyard information collection and management system. The system comprises a central computing system for storing, processing, and analyzing real-time information about one or more vineyards; a first remote computing system located at a data source; a second remote computing system located at a remote user; a network (e.g., the Internet) interconnecting the central computing system with the first and second remote computing systems; a plurality of forms transmitted over the network to the first remote computing system for allowing the data source to enter the real-time information about the one or more vineyards, the real-time information transmitted to the central computing system; and a plurality of reports produced by the central computing system and transmitted over the network to the second remote computing system, the reports summarizing the real-time information and including analyses of the real-time information to allow the remote user to make purchasing, operations, and management decisions about the one or more vineyards. The system includes a plurality of software modules for collecting, processing, and analyzing data provided by a data source and producing reports for one or more users useful in making purchasing, operations, and management decisions at a vineyard, including a yield forecasting module, a harvest maturity and prediction module, an irrigation scheduling module, an alert module, a pest management module, a nutritional analysis module, a weather module, a canopy management module, and an operational scheduling module. The invention is expandable to accommodate additional modules for processing desired vineyard information.

The present invention also provides a method for managing information about one or more vineyards. The method comprises the steps of providing a central computing system for storing, processing, and analyzing real-time information about one or more vineyards; providing a first remote computing system located at a data source; providing a second remote computing system located at a remote user; interconnecting the central computing system and the first and second remote computing systems with a network (e.g., the Internet); transmitting at least one form over the network to the first remote computing system; allowing the data source to enter information about a vineyard using the at least one form; storing, processing, and analyzing the information at the central computing system; and producing a report summarizing and analyzing the information to assist in making purchasing, operations, and management decisions about the vineyard, the report accessible by the user at the second remote computing system. More than one report can be generated and can include information about one or more vineyards including yield forecasts, harvest predictions, irrigation schedules, alerts, pest summaries, tissue information, soil information, nutrient information, weather information, vine growth and balance information, and operational schedules and activities. Data can be collected, managed, analyzed, and reported from a virtually unlimited number of sources.

The present invention further provides a method for allowing a winery to acquire and manage information at a vineyard. The method comprises the steps of providing a central computer system for storing, processing, and analyzing real-time information about one or more vineyards; providing a data source with a portable computer system; allowing the data source to travel to the one or more vineyards; allowing the data source to enter real-time information into one or more forms on the portable computer system about the one or more vineyards; transmitting the information to the central computing system; storing and processing the information at the central computing system; providing one or more wineries with one or more reports containing real-time information about the one or more vineyards; and allowing the one or more wineries to make purchasing decisions about the one or more vineyards using the real-time information in the one or more reports. Data can be entered directly into the central computer system over a computer network, such as the Internet.

### BRIEF DESCRIPTION OF THE DRAWINGS

Other important objects and features of the invention will be apparent from the following Detailed Description of the Invention taken in connection with the accompanying drawings in which:

FIG. 1 is a diagram showing the hardware architecture of the vineyard information collection and management system of the present invention.

FIG. 2 is a diagram showing various input and output data types handled by the present invention.

FIG. 3 is a diagram showing software modules of the present invention.

FIGS. 4A-4F are flowcharts showing processing logic of the yield forecasting module of the present invention.

FIGS. 5A-5E are images showing user interface screens generated by the yield forecasting module of the present invention.

FIGS. 6A-6D are flowcharts showing processing logic of the maturity tracking/harvest prediction module of the present invention.

FIGS. 7A-7D are images showing user interface screens generated by the maturity tracking/harvest prediction module of the present invention.

FIGS. 8A-8C are flowcharts showing processing logic of the irrigation scheduling module of the present invention.

FIGS. 9A-9B are images showing user interface screens generated by the irrigation scheduling module of the present invention.

FIG. 10 is a flowchart showing processing logic of the alert module of the present invention.

FIGS. 11A-11B are images showing user interface screens generated by the alert module of the present invention.

FIGS. 12A-12D are flowcharts showing processing logic of the pest management module of the present invention.

FIGS. 13A-13F are images showing user interface screens generated by the pest management module of the present invention.

FIGS. 14A-14D are flowcharts showing processing logic of the nutritional analysis module of the present invention.

FIGS. 15A-15J are images showing user interface screens generated by the nutritional analysis module of the present invention.

FIG. 16 is a flowchart showing processing logic of the weather module of the present invention.

FIGS. 17A-17B are images showing user interface screens generated by the weather module of the present invention.

FIG. 18 is a flowchart showing processing logic of the canopy management module of the present invention.

FIGS. 19A-19D are images showing user interface screens generated by the canopy management module of the present invention.

FIG. 20 is a flowchart showing processing logic of the operational scheduling/timeline module of the present invention.

FIGS. 21A-21E are images showing user interface screens generated by the operational scheduling/timeline module of the present invention.

### DETAILED DESCRIPTION OF THE INVENTION

The present invention provides a vineyard information collection and management system. The system allows a variety of information at one or more vineyards to be collected in real time, processed at a central server, and provided to users over the Internet using customizable, easy-to-use forms and pages accessible using a conventional web browser. The system includes data collection, analysis, planning, and management tools that assist in making purchasing, operations, and management decisions at one or more vineyards. The invention includes a plurality of software modules that provide useful, real-time information about vineyards, including a yield forecasting module, a maturity tracking/harvest prediction module, an irrigation scheduling module, an alert module, a pest management module, a nutritional analysis module, a weather module, a canopy management module, and an operational scheduling/timeline module. The invention provides comprehensive reports accessible via the Internet, containing useful information about vineyards, including water status, pest status, nutrient status, soil status, weather information, viticultural alerts, crop yield predictions, crop analysis information, grape maturity tracking, farm planning status, work orders, schedules, timelines, wine analysis, imagery, multi-dimensional maps, and other information.

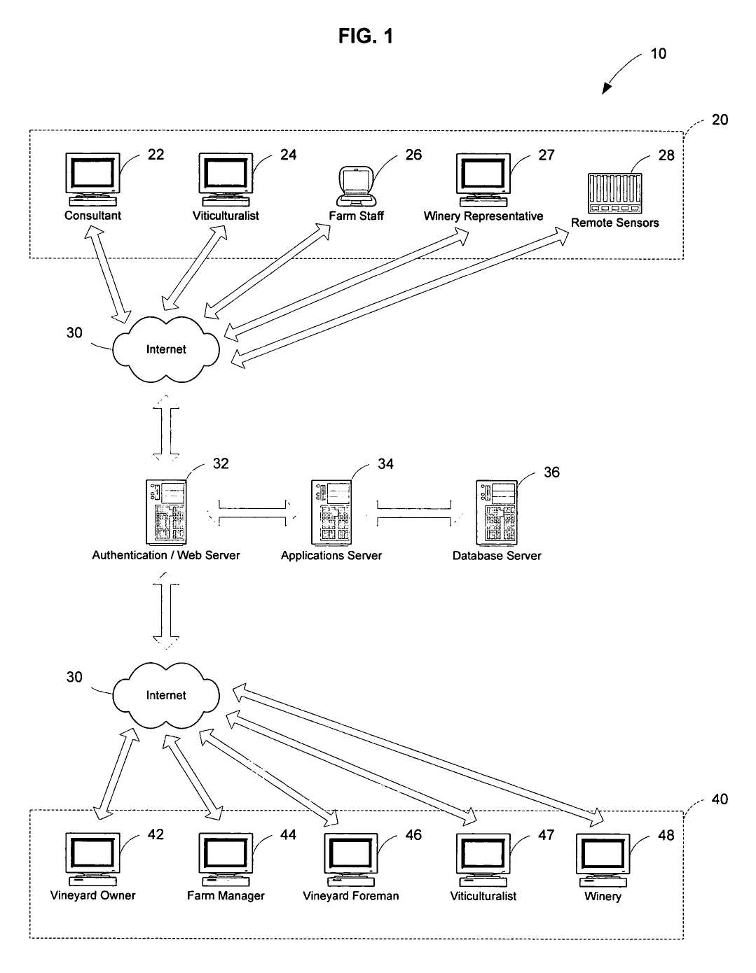

FIG. 1 is a diagram showing the hardware architecture of the vineyard information collection and management system of the present invention, indicated generally at 10. The vineyard information collection and management system 10 provides a central repository of real-time information about one or more vineyards that is easily accessible via the Internet and which provides a wealth of information useful in making purchasing, operations, and management decisions. The vineyard information collection and management system 10 allows a plurality of data sources 20 and users 40 to interact with the system 10 using the Internet 30. The system 10 includes an authentication and/or web server 32, which provides a gateway to Internet 30 and produces each of the user interface screens of the present invention, in addition to an applications server 34 and a database server 36. The applications server 34 handles database and information processing requests received by the authentication/web server 32, and dispatches database requests to the database server 36. The database server 36 stores vineyard information generated by the data sources 20 and/or the users 40. It should be noted that the Internet 30 could be substituted with any suitable type of communications network, such as a wired or wireless Local Area Network (LAN) or Wide Area Network (WAN).

Each of the servers 32, 34, 36 could comprise any suitable, commercially-available server running any suitable operating system, such as Microsoft Windows XP, UNIX, or any other suitable operating system. The authentication/web server 32 could include the Microsoft Internet Information Server (IIS) software for generating user interface screens (including forms and reports) accessible via standard web browsers over the Internet 30. The applications server 34 could include the ColdFusion Scripting Environment and Sun Microsystems J2EE Infrastructure Services software packages for processing and handling data requests. The database server 36 could include the Microsoft SQL Server software package for providing database functionality. It should be noted that any suitable hardware and software could be substituted for servers 32, 34, 36 without departing from the spirit or scope of the present invention.

Data sources 20 provide a variety of vineyard information that is processed, managed, and presented by the system 10 for use by users 40. The data sources 20 could include one or more consultants 22, viticulturalists 24, farm staff 26, winery representatives 27, remote sensors 28, or any other desired source of information. Each of the data sources can communicate with the system 10 using the Internet 30. For example, the data sources 20 could comprise remote workstations connected to the Internet, wherein information is entered using the user interface screens generated by the web server 32 and processed by the applications and database servers 34, 36. Moreover, vineyard information can be entered using portable computing equipment (e.g., personal digital assistants (PDAs) laptops, palmtops, etc.), which could be connected to the Internet using wired or wireless network connections. The remote sensors 28 can monitor field conditions and can provide information including, but not limited to, soil conditions, time, temperature, light conditions, weather information, grape information, vine information, nutrients, irrigation information, or any other desired information. The remote sensors 28 can also communicate with the system 10 using wired or wireless Internet connections. Other types of connections, such as cell phone, telemetry, or telephone connections, are also possible. The data provided by the data sources 20 can be processed in real time by the system 10, and monitored and utilized in real time by the users 40 to make management and purchasing decisions at one or more vineyards or other locations involved in the grape growing and/or winemaking process.

Users 40 could include any desired user of the system 10 of the present invention, including, but not limited to, one or more vineyard owners 42, farm managers 44, vineyard foremen 46, viticulturalists 47, and wineries 48. Importantly, the system 10 allows each of the users 40 to access vineyard information in real time to assist with purchasing, management, and operations decisions at one or more vineyards.

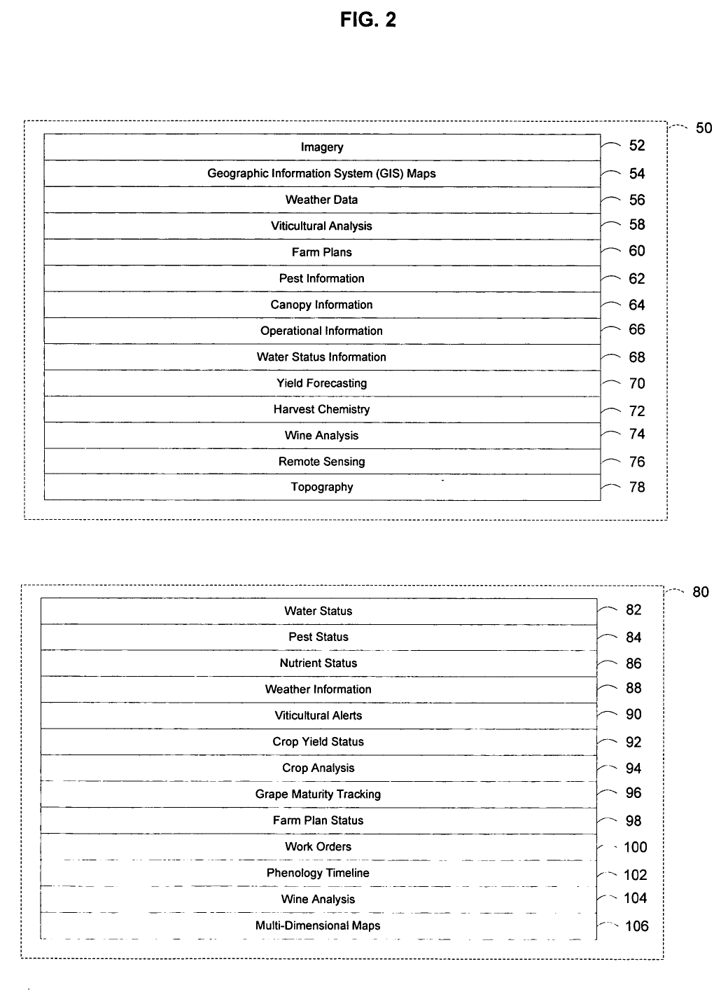

FIG. 2 is a diagram showing various input and output data types handled by the present invention. Data inputs 50 could include imagery information 52, geographic information system (GIS) maps 54, weather information 56, viticultural analysis information 58, farm plans 60, pest information 62, canopy information 64, operational information 66, water status information 68, yield forecasting information 70, harvest chemistry information 72, wine analysis information 74, remote sensing information 76, topography information 78, or any other desired information. Data outputs 80 could include water status information 82, pest status information 84, nutrient status information 86, weather information 88, viticultural alerts 90, crop yield status 92, crop analysis information 94, grape maturity tracking information 96, farm planning information 98, work orders 100, phenology timelines 102, wine analysis 104, multi-dimensional maps 106, or any other desired information useful in making purchasing, management, and operations decisions at one or more vineyards.

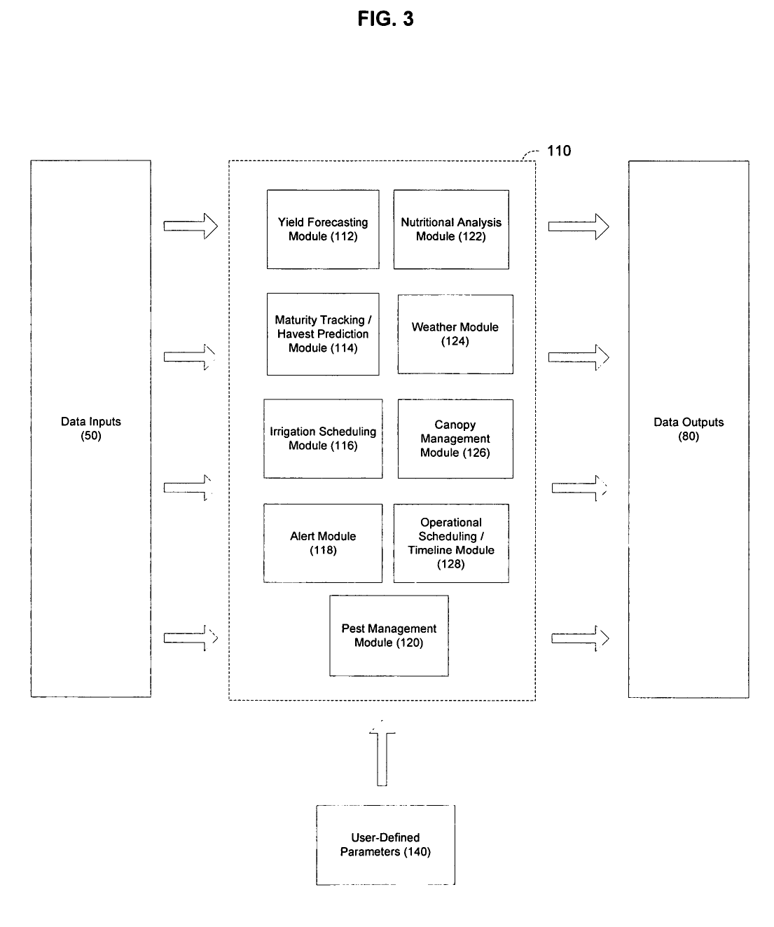

FIG. 3 is a diagram showing software modules of the present invention, indicated generally at 110. Each of the modules 110 provides functionality for processing one or more of the data inputs 50 and produces one or more data outputs 80. Further, each of the modules 110 produces customizable forms accessible via a standard web browser for allowing data entry and reports summarizing real-time vineyard information. The modules 110 include, but are not limited to, yield forecasting module 112, maturity tracking/harvest prediction module 114, irrigation scheduling module 116, alert module 118, pest management module 120, nutritional analysis module 122, weather module 124, canopy management module 126, and operational scheduling/timeline module 128. It should be noted that additional modules can be included for handling future data inputs without departing from the spirit or scope of the present invention.

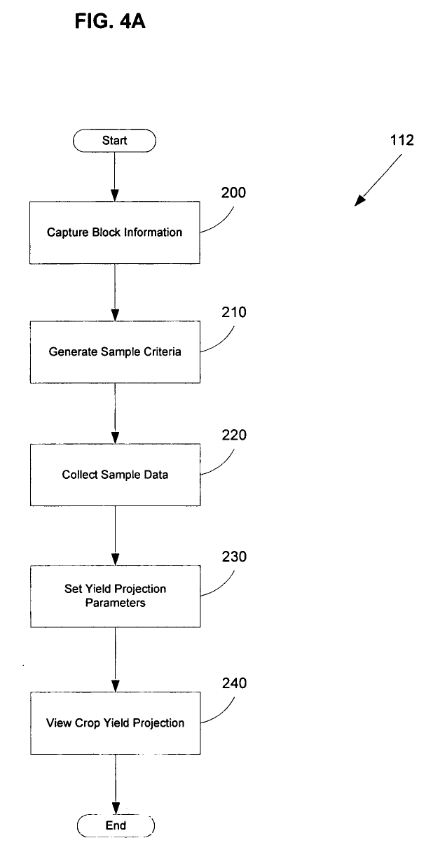

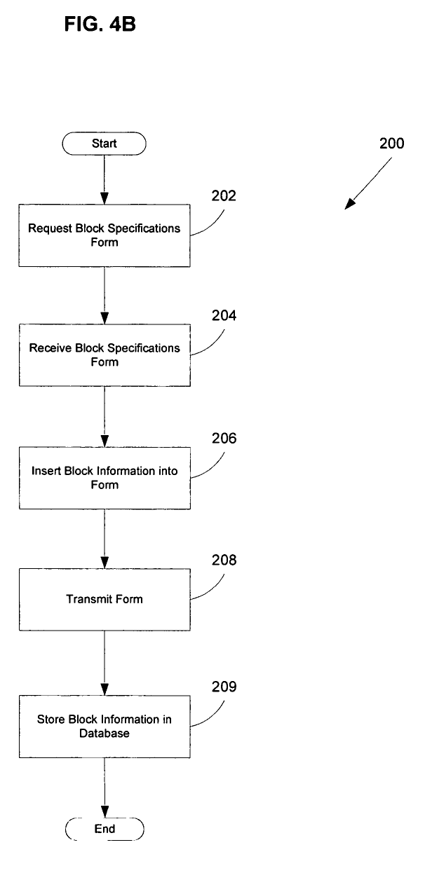

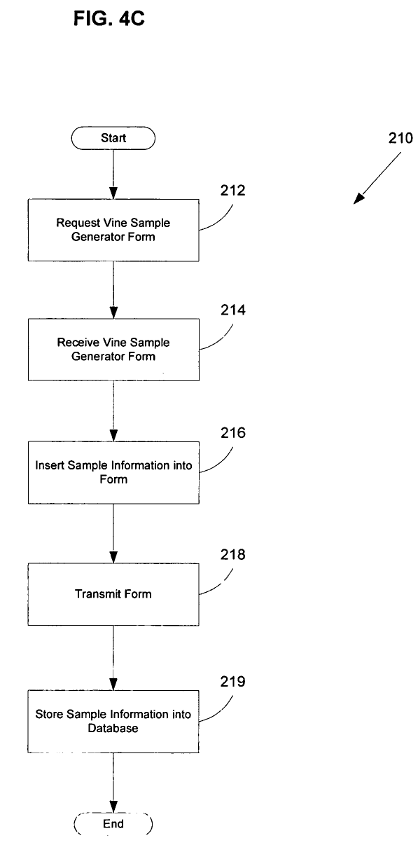

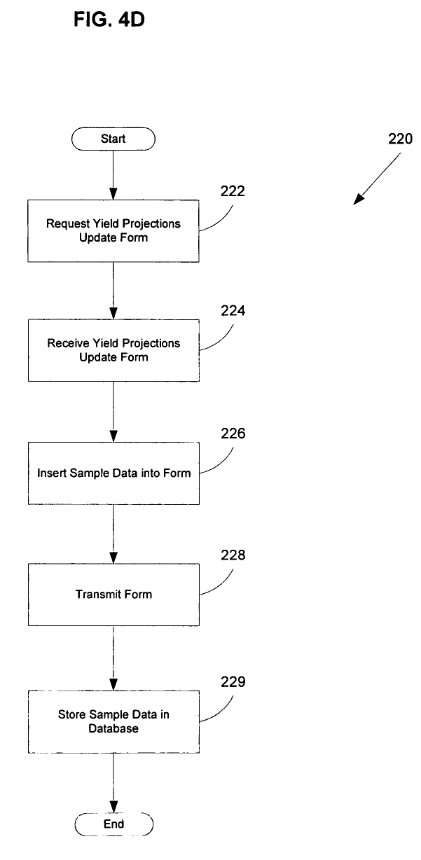

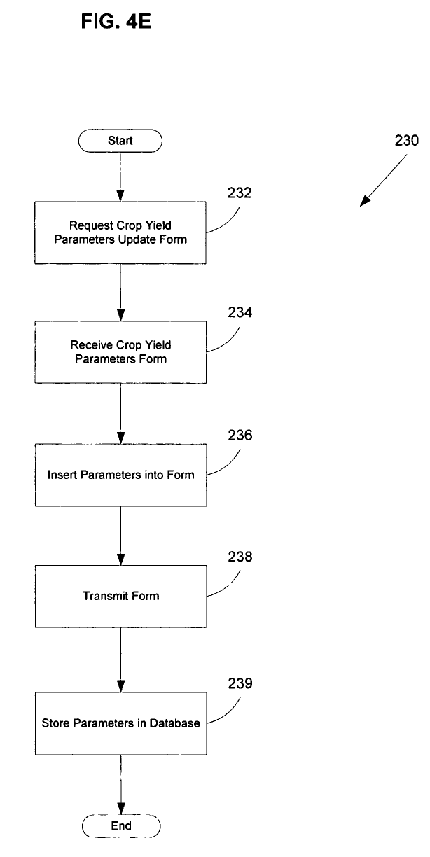

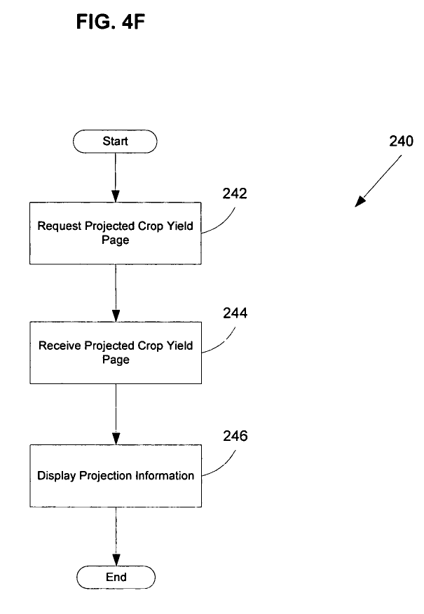

FIGS. 4A-4F are flowcharts showing processing logic of the yield forecasting module 112 of the present invention. The yield forecasting module 112 allows crop yield information for one or more vineyards to be produced in real time and presented in simple, easy to use forms accessible over the Internet using a standard web browser. The overall processing steps of the yield forecasting module 112 are shown in FIG. 4A. Beginning in step 200, block information about a vineyard is collected from one or more of the data sources 20 of FIG. 1. Optionally, this information could be collected from one or more of the users 40 of FIG. 1. Then, in steps 210 and 220, sample criteria information is gathered and sample data is collected. In step 230, yield projection parameters are defined by the user. In step 240, crop yield projections are calculated and displayed to the user, in real time. The processing shown in FIG. 4A can be repeated as desired to accommodate any number of vineyards.

FIG. 4B shows the processing logic of step 200 of FIG. 4A in greater detail. In step 202, a block specifications form is requested by a data source 20 (or, optionally, a user 40) and transmitted thereto via the Internet. The block specifications form could comprise a web page accessible via the Internet, wherein block information can be entered. In step 204, the block specifications form is received by the data source or user, and in step 206, block information is entered. The block information could include, but is not limited to, winery name, acreage, variety, block name, root stock, root stock source, scion clone, scion source, year planted, year budded, row spacing, vine spacing, trellis type, row numbers, row direction, aspect, soil texture, grade percent, soil texture, training, number of wires, emitters per vine, emitter rate, frost protection, and foreman identification. Once the desired block information has been entered into the form, in step 208 the form is transmitted to the present invention. Thereafter, in step 209, the data in the form is stored in a central database (e.g., in the database server 36 of FIG. 1) for future processing.

FIG. 4C shows the processing logic of step 210 of FIG. 4A in greater detail. In step 212, a vine sample generator form is requested by a data source 20 (or, optionally, a user 40) and transmitted thereto via the Internet. The vine sample generator form could comprise a web page accessible via the Internet, wherein vine sample information can be entered. In step 214, the vine sample generator form is received by a data source or user, and in step 216, sample information is entered. The sample information could include, but is not limited to, berry count information. Once the desired sample information has been entered into the form, in step 218 the form is transmitted to the present invention. Thereafter, in step 219, the data in the form is stored in a central database (e.g., in the database server 36 of FIG. 1) for future processing.

FIG. 4D shows the processing logic of step 220 of FIG. 4A in greater detail. This step allows yield projections to be updated by entering additional sample data. In step 222, a yield projections update form is requested by a data source 20 (or, optionally, a user 40) and transmitted thereto via the Internet. The yield projections update form could comprise a web page accessible via the Internet, wherein sample information can be entered. In step 224, the yield projections update form is received by the data source or user, and in step 226, additional sample information is entered. Once the additional sample information has been entered into the form, in step 228 the form is transmitted to the present invention. Thereafter, in step 229, the data in the form is stored in a central database (e.g., in the database server 36 of FIG. 1) for future processing.

FIG. 4E shows the processing logic of step 230 of FIG. 4A in greater detail. In step 232, a crop yield parameters update form is requested by a data source 20 (or, optionally, a user 40) and transmitted thereto via the Internet. The crop yield parameters update form could comprise a web page accessible via the Internet, wherein parameters for projecting crop yields can be entered. In step 234, the crop yield parameters update form is received by a data source or user, and in step 216, parameters for crop yields are entered. Examples of yield parameters that can be defined include, but are not limited to, bunch weights, bunch gains and losses, harvest efficiencies, and desired variations. Once the desired yield parameters have been entered into the form, in step 238 the form is transmitted to the present invention. Thereafter, in step 239, the data in the form is stored in a central database (e.g., in the database server 36 of FIG. 1) for future processing.

The aforementioned information provided in FIGS. 4A-4E are processed by the present invention to provide crop yield projections. The projections are calculated by the present invention using random samples of grape bunches and berry weights collected prior to harvest. The crop yield projections can be displayed in any desired units, such as tons per acre or total tons. As shown in FIG. 4F, which is a flowchart showing the processing logic of step 240 of FIG. 4A in greater detail, the crop yield projections can be provided in a concise, easy-to-interpret web page accessible via the Internet. In step 242, the projected crop yield page is requested by a data source or user and transmitted thereto in step 244 via the Internet. Then, in step 246, the projection information is displayed to the data source or user, thereby providing real-time yield projection information that can be used in making purchasing, operations, and management decisions.

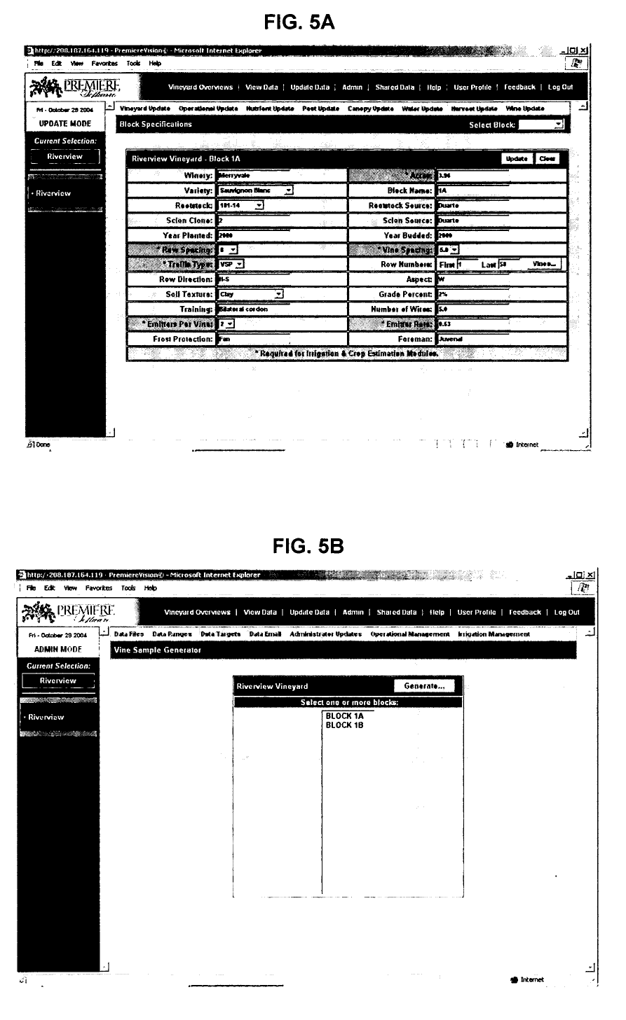

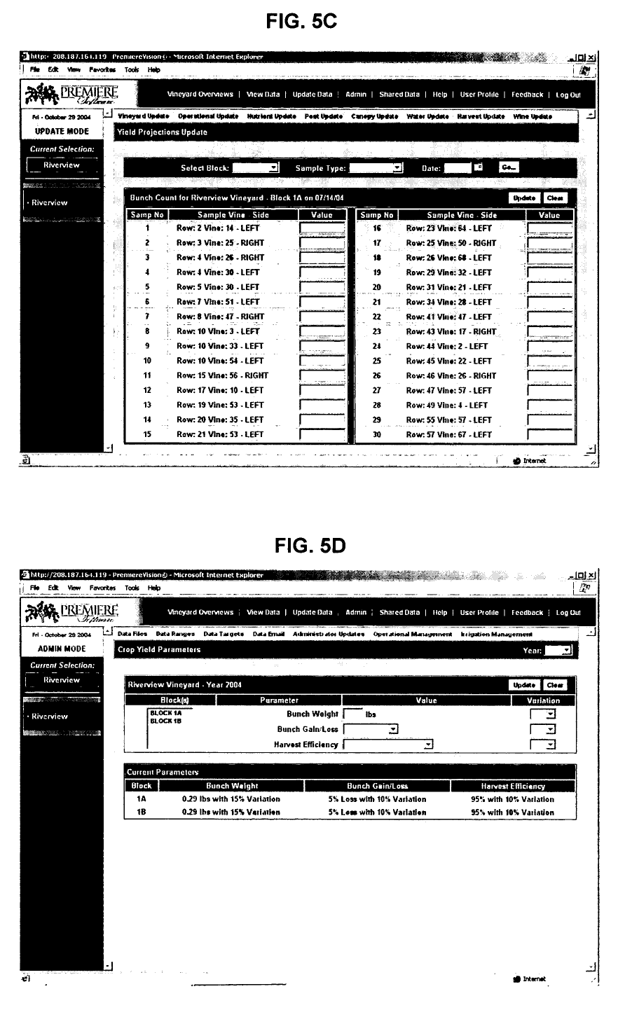

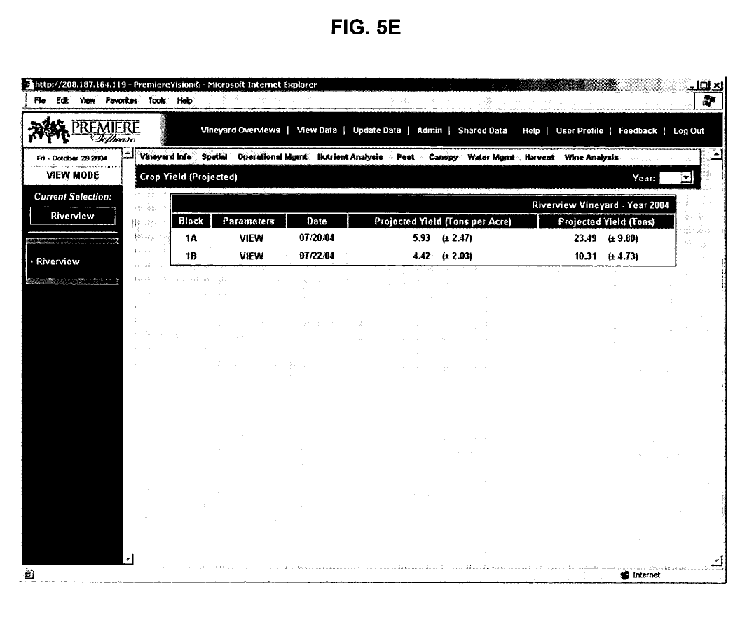

FIGS. 5A-5E are images showing user interface screens generated by the yield forecasting module of the present invention. Shown in FIG. 5A is the block specifications form discussed earlier with respect to FIG. 4B, wherein block information can be entered by a data source and/or user. The form includes a number of data entry fields and pull-down menus that can be customized as desired and which are easy to use. Shown in FIGS. 5B and 5C are the vine sample generator and yield projection update forms discussed earlier with respect to FIGS. 4C and 4D, which allow the user to define and enter vine sample information and update same as desired. FIG. 5D shows the crop yield parameters form discussed earlier with respect to FIG. 4E, wherein yield projection parameters can be defined and adjusted by the user as desired. FIG. 5E show the crop yield page generated by the yield projection module of the present invention, wherein yield projections are generated in real time. As can be readily appreciated, the customizable forms of the yield projection module allow crop information to be quickly and conveniently gathered from one or more data sources and/or users, and projections to be generated in real time, all accessible via the Internet using any suitable computing device.

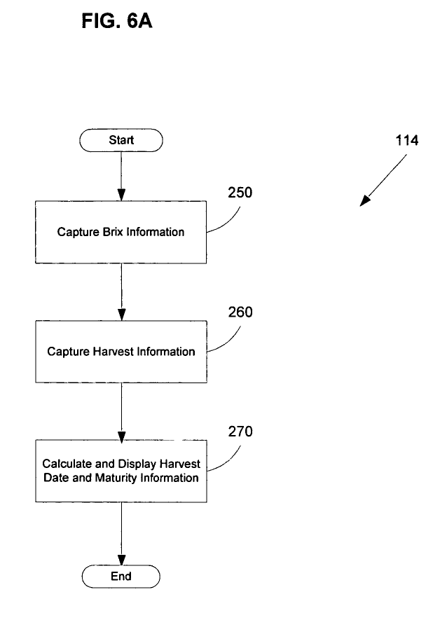

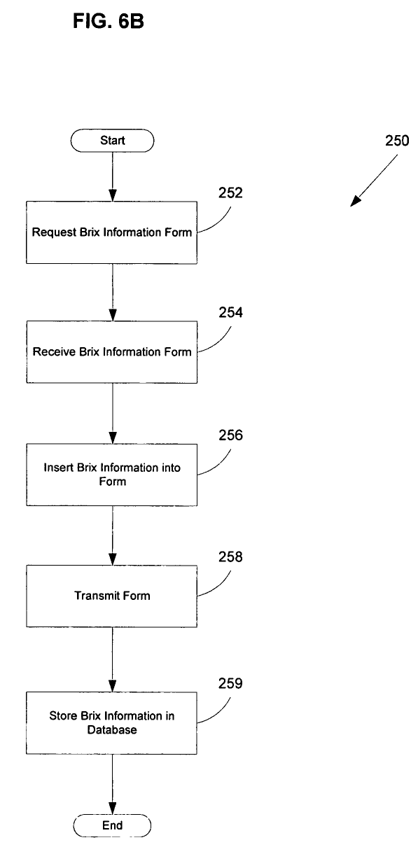

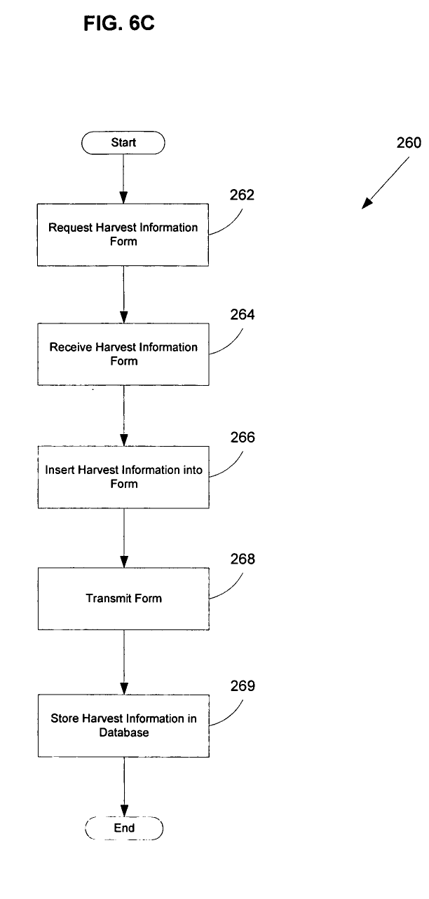

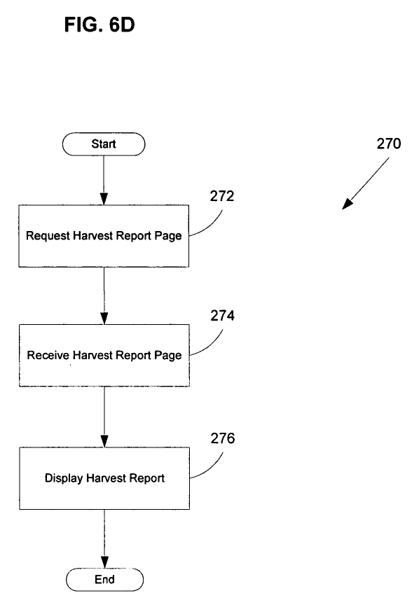

FIGS. 6A-6D are flowcharts showing processing logic of the maturity tracking/harvest prediction module 114 of the present invention. The module 114 allows maturity information for one or more crops (e.g., grapes) at one or more vineyards to be produced in real time and presented in simple, easy to use forms accessible over the Internet using a standard web browser. The overall processing steps of the module 114 are shown in FIG. 6A. Beginning in step 250, brix information for one or more crops is collected from one or more of the data sources 20 of FIG. 1. Optionally, this information could be collected from one or more of the users 40 of FIG. 1. Then, in step 260, harvest information is collected. In step 270, one or more harvest dates are calculated and displayed in real time using the harvest information collected in step 260. Additionally, crop maturity information is calculated and displayed in real time. The processing shown in FIG. 6A can be repeated as desired to accommodate any number of vineyards.

FIG. 6B shows the processing logic of step 250 of FIG. 6A in greater detail. In step 252, a brix information form is requested by a data source 20 (or, optionally, a user 40) and transmitted thereto via the Internet. The brix information form could comprise a web page accessible via the Internet, wherein brix information can be entered. In step 204, the brix information form is received by the data source or user, and in step 206, brix information is entered. The brix information could include, but is not limited to, block identifiers, current target brix information, and new target brix information. Once the desired brix information has been entered into the form, in step 258 the form is transmitted to the present invention. Thereafter, in step 259, the data in the form is stored in a central database (e.g., in the database server 36 of FIG. 1) for future processing.

FIG. 6C shows the processing logic of step 260 of FIG. 6A in greater detail. In step 262, a harvest information form is requested by a data source 20 (or, optionally, a user 40) and transmitted thereto via the Internet. The harvest information form could comprise a web page accessible via the Internet, wherein harvest range data can be entered. In step 264, the harvest information form is received by a data source or user, and in step 266, harvest information is entered. The harvest information could include, but is not limited to, block identifications, source identifications, dates, brix information, pH, sample size, Titratable Acidity (TA), berry weights, number of berries, cluster weights, and number of clusters. Once the desired harvest information has been entered into the form, in step 268 the form is transmitted to the present invention. Thereafter, in step 269, the data in the form is stored in a central database (e.g., in the database server 36 of FIG. 1) for future processing.

The aforementioned information provided in FIGS. 6A-6C are processed by the present invention to provide crop maturity, harvest date projections, and other information about a harvest. The harvest date projections are calculated utilizing a trend formula to project a harvest date based on grape sugar samples collected prior to harvest. As shown in FIG. 6D, which is a flowchart showing the processing logic of step 270 of FIG. 6A in greater detail, the crop maturity and harvest date projections can be provided in one or more concise, easy-to-interpret web pages accessible via the Internet. In step 272, a harvest report page is requested by a data source or user and transmitted thereto in step 274 via the Internet. Then, in step 276, crop maturity, harvest date projections, and other information are displayed in the harvest report page, thereby providing real-time yield crop maturity and harvest date projections that can be used in making purchasing, operations, and management decisions.

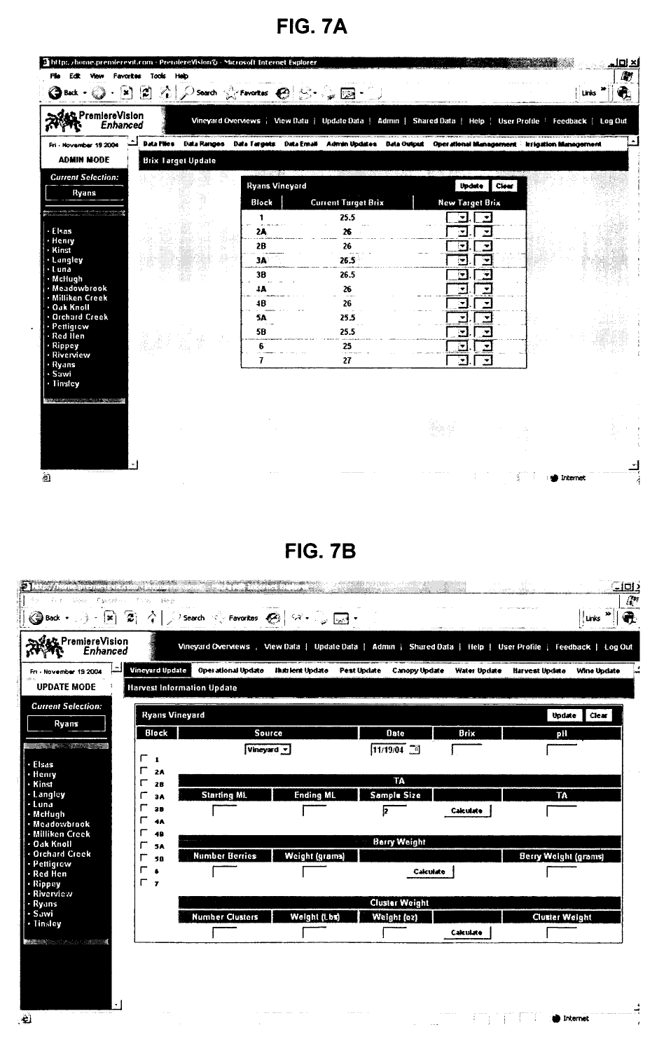

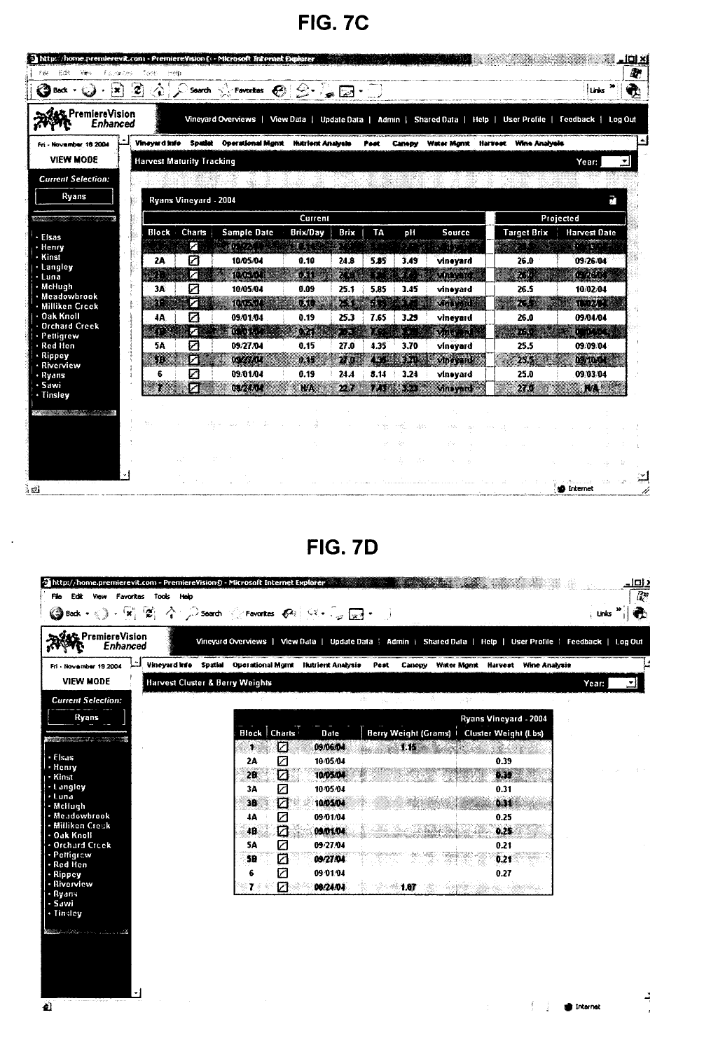

FIGS. 7A-7D are images showing user interface screens generated by the maturity tracking/harvest date prediction module of the present invention. Shown in FIG. 7A is the brix information form discussed earlier with respect to FIG. 6B, wherein brix information can be entered by a data source and/or user. The form includes a number of data entry fields and pull-down menus that can be customized as desired and which are easy to use. Shown in FIG. 7B is the harvest information form discussed earlier with respect to FIG. 6C, which allows for the entry of harvest information. FIGS. 7C and 7D show the harvest report pages generated by the maturity tracking/harvest date prediction module of the present invention, wherein harvest information including crop maturity, harvest prediction dates, and berry and cluster summaries are generated in real time. As can be readily appreciated, the customizable forms of the maturity tracking/harvest date prediction module allow harvest information to be quickly and conveniently gathered from one or more data sources and/or users, and projections to be generated in real time, all accessible via the Internet using any suitable computing device.

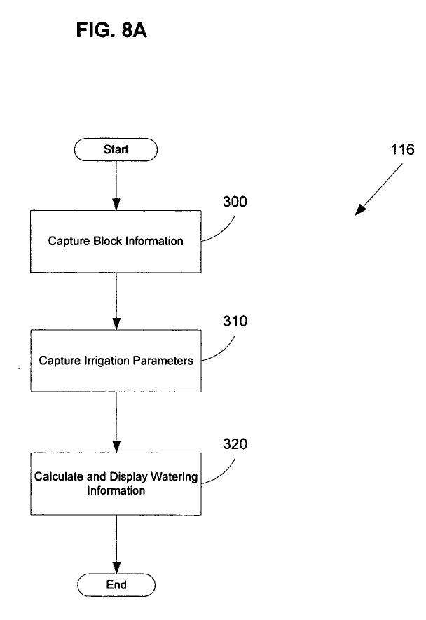

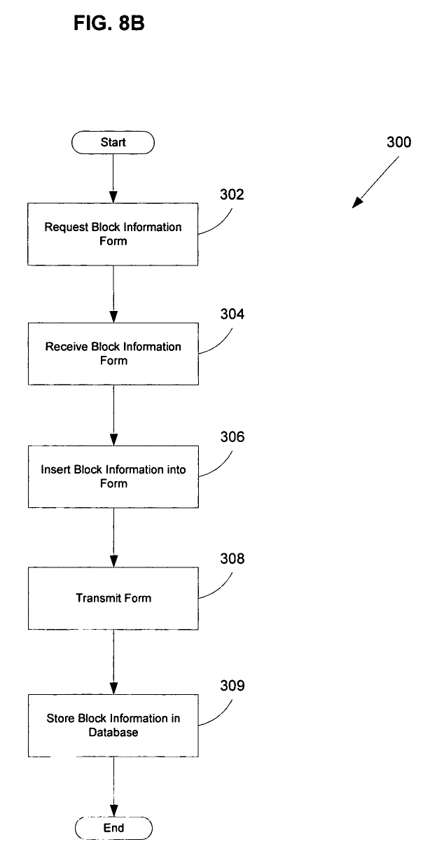

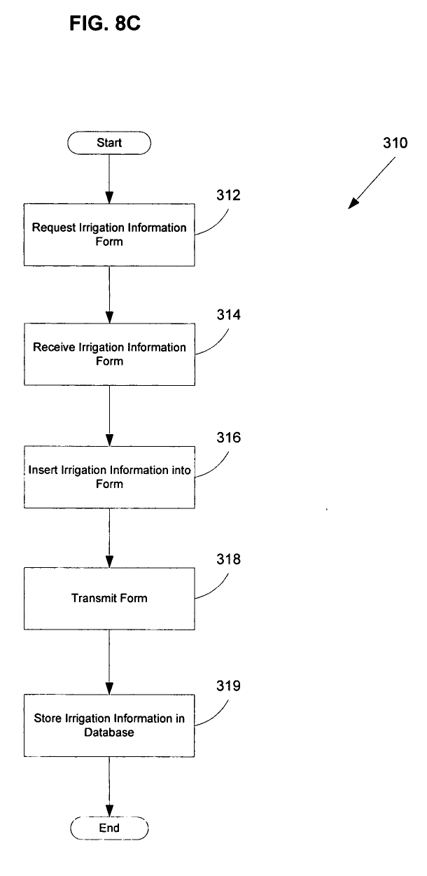

FIGS. 8A-8C are flowcharts showing processing logic of the irrigation scheduling module 116 of the present invention. The module 116 allows irrigation schedules and timing to be calculated in real time for one or more vineyards. The overall processing steps of the module 116 are shown in FIG. 8A. Beginning in step 300, block information is collected from one or more of the data sources 20 of FIG. 1. Optionally, this information could be collected from one or more of the users 40 of FIG. 1. Then, in step 310, irrigation parameters are defined. In step 320, watering information is calculated and displayed in real time using the block information and irrigation parameters collected in steps 300 and 310. The processing shown in FIG. 8A can be repeated as desired to accommodate any number of vineyards.

FIG. 8B shows the processing logic of step 300 of FIG. 8A in greater detail. In step 302, a block information form is requested by a data source 20 (or, optionally, a user 40) and transmitted thereto via the Internet. The block information form is similar to the block information form discussed earlier with respect to FIG. 4B, and could comprise a web page accessible via the Internet. The block information form allows information about a vineyard block to be entered, including, but not limited to, winery name, acreage, variety, block name, root stock, root stock source, scion clone, scion source, year planted, year budded, row spacing, vine spacing, trellis type, row numbers, row direction, aspect, soil texture, grade percent, soil texture, training, number of wires, emitters per vine, emitter rate, frost protection, and foreman identification. In step 304, the block information form is received by the data source or user, and in step 306, block information is entered. Once the desired block information has been entered into the form, in step 308 the form is transmitted to the present invention. Thereafter, in step 309, the data in the form is stored in a central database (e.g., in the database server 36 of FIG. 1) for future processing.

FIG. 8C shows the processing logic of step 310 of FIG. 8A in greater detail. In step 312, an irrigation information form is requested by a data source 20 (or, optionally, a user 40) and transmitted thereto via the Internet. The irrigation information form could comprise a web page accessible via the Internet, wherein irrigation information can be entered. In step 314, the irrigation information form is received by a data source or user, and in step 316, irrigation information is entered. The irrigation information could include, but is not limited to, irrigation schedules, vineyard information, block information, crop variety, clone information, rootstock information, watering date, weekly evapotranspiration (ET), degree days (in Celsius or Fahrenheit units), ET percentage, and hours of watering. Once the desired irrigation information has been entered into the form, in step 318 the form is transmitted to the present invention. Thereafter, in step 319, the data in the form is stored in a central database (e.g., in the database server 36 of FIG. 1) for future processing.

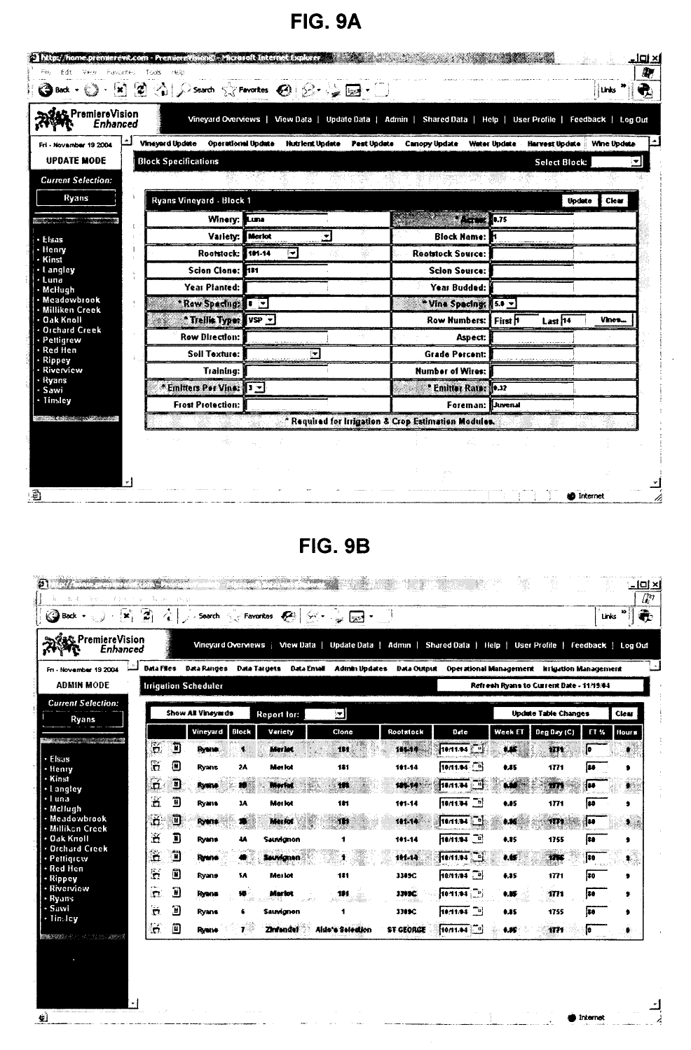

FIGS. 9A-9B are images showing user interface screens generated by the irrigation scheduling module 116 of the present invention. Shown in FIG. 9A is the block information form discussed earlier with respect to FIG. 8B, wherein block information can be entered by a data source and/or user. The form includes a number of data entry fields and pull-down menus that can be customized as desired and which are easy to use. Shown in FIG. 9B is the irrigation information form discussed earlier with respect to FIG. 8C, which allows for the entry of harvest information. The form displays irrigation scheduling information in the form of a table that can be edited and updated as desired, and which can include irrigation information for one or more vineyards.

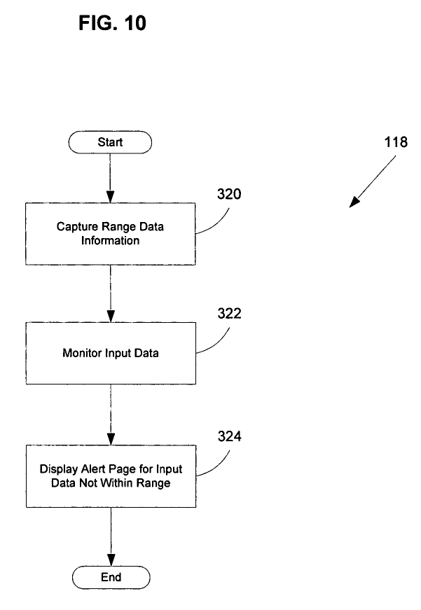

FIG. 10 is a flowchart showing processing logic of the alert module 118 of the present invention. The alert module 118 allows a user or data source to define input data ranges representing acceptable values, and monitors input data to determine whether the input data is within one or more of the ranges. If the input data is not within an acceptable range, an alert is generated and displayed on an alert page. Beginning in step 320, a range data information page is received by a user or data source, and range data is entered by the user. The range data could include, but is not limited to, pressure ranges, temperature ranges, or other desired range information. When the range data information is entered by the user, the range data information page is received by the present invention and range data extracted therefrom and stored in a database (such as the database server 36 of FIG. 1). In step 322, the alert module 118 monitors input data to determine whether the data falls within one or more ranges defined in step 320. If the data does not fall within the one or more ranges, in step 324 an alert page is displayed for all input data not within the one or more ranges. For example, the alert page could indicate the vineyard where each alert occurred, the alert type, data value that triggered the alert, and a short description about the alert.

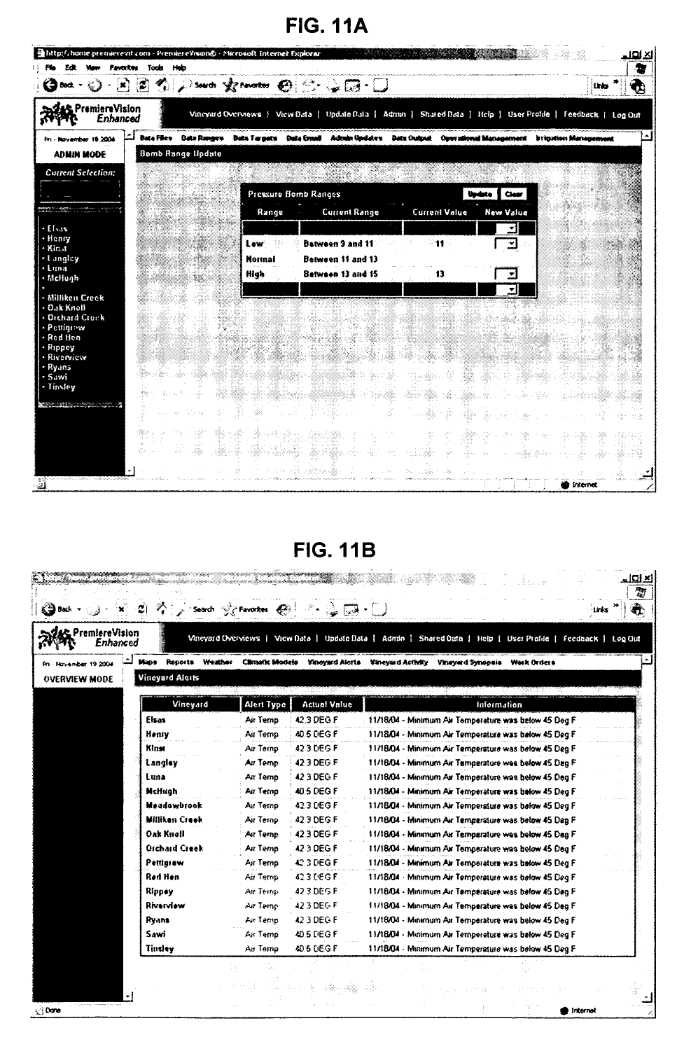

FIGS. 11A-11B are images showing user interface screens generated by the alert module 118 of the present invention. Shown in FIG. 11A is the range data information page discussed earlier with respect to step 320 of FIG. 10, wherein range information can be defined by a user or a data source. The page allows a variety of ranges to be defined in addition to values for each range. Shown in FIG. 11B is a sample alert page generated by the alert module 118 of the present invention, wherein air temperature alerts are shown for a plurality of vineyards. The page displays the vineyard name, alert type, actual value, and information about each alert.

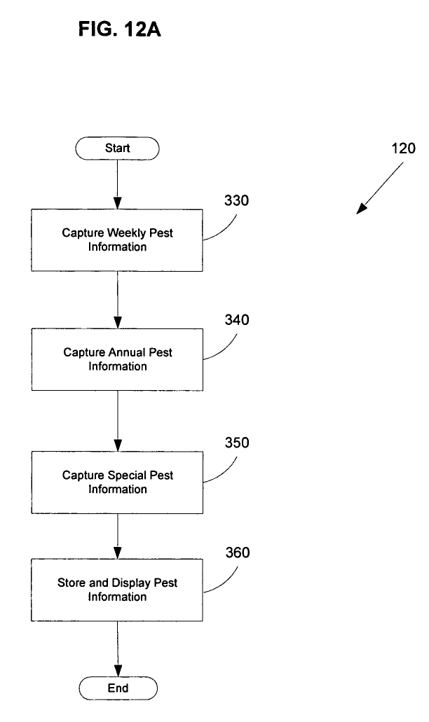

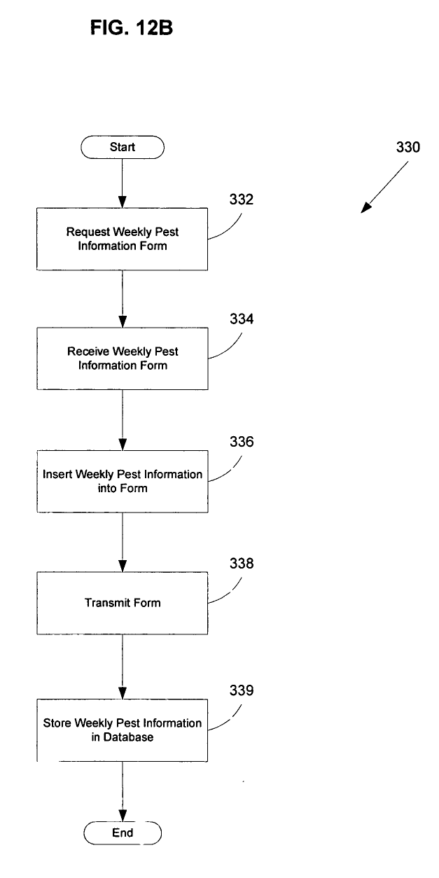

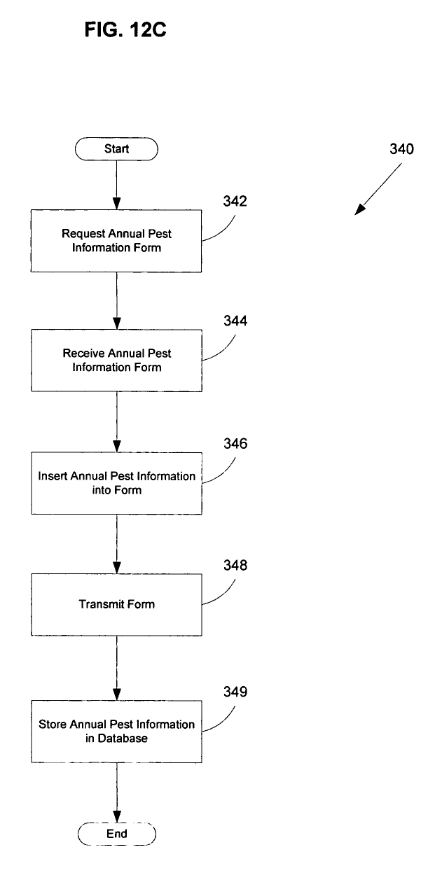

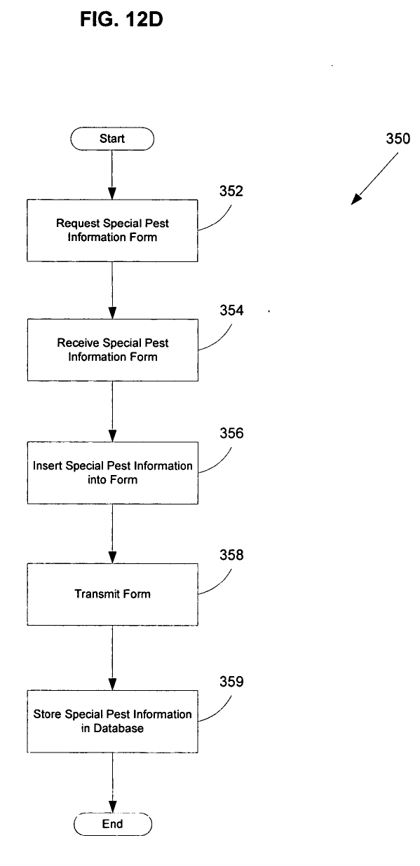

FIGS. 12A-12D are flowcharts showing processing logic of the pest management module 120 of the present invention. The module 120 allows pest information for one or more vineyards to be tracked and managed in real time, and management information presented in simple, easy to use forms accessible over the Internet using a standard web browser. The overall processing steps of the module 120 are shown in FIG. 12A. Beginning in step 330, weekly pest information for one or more vineyards is collected from one or more of the data sources 20 of FIG. 1. Optionally, this information could be collected from one or more of the users 40 of FIG. 1. Further, optionally, yearly pest information could be captured in step 340. In step 350, special pest information is collected. In step 360, pest information is stored and displayed in real time using the information collected in steps 330-350. The processing shown in FIG. 12A can be repeated as desired to accommodate any number of vineyards.

FIG. 12B shows the processing logic of step 330 of FIG. 12A in greater detail. In step 332, a weekly pest information form is requested by a data source 20 (or, optionally, a user 40) and transmitted thereto via the Internet. The weekly pest information form could comprise a web page accessible via the Internet, wherein weekly pest information can be entered. In step 334, the weekly pest information form is received by the data source or user, and in step 336, weekly pest information is entered. The weekly pest information could include, but is not limited to, block identifiers, dates, mildew values, botryis values, percentage of mites, and leafhopper information. Once the desired weekly pest information has been entered into the form, in step 338 the form is transmitted to the present invention. Thereafter, in step 339, the data in the form is stored in a central database (e.g., in the database server 36 of FIG. 1) for future processing.

FIG. 12C shows the processing logic of step 340 of FIG. 12A in greater detail. In step 342, an annual pest information form is requested by a data source 20 (or, optionally, a user 40) and transmitted thereto via the Internet. The annual pest information form could comprise a web page accessible via the Internet, wherein annual pest information can be entered. In step 344, the annual pest information form is received by a data source or user, and in step 346, annual pest information is entered. The annual pest information could include, but is not limited to, year, block information, pest information, number of incidences, and severity of incidences. Once the desired annual pest information has been entered into the form, in step 348 the form is transmitted to the present invention. Thereafter, in step 349, the data in the form is stored in a central database (e.g., in the database server 36 of FIG. 1) for future processing.

FIG. 12D shows the processing logic of step 350 of FIG. 12A in greater detail. In step 352, a special pest information form is requested by a data source 20 (or, optionally, a user 40) and transmitted thereto via the Internet. The special pest information form could comprise a web page accessible via the Internet, wherein special pest information can be entered. In step 354, the special pest information form is received by a data source or user, and in step 356, special pest information is entered. The special pest information could include, but is not limited to, pest lists, trap identifiers, trap installation dates, and counts of trapped pests. Once the desired special pest information has been entered into the form, in step 358 the form is transmitted to the present invention. Thereafter, in step 359, the data in the form is stored in a central database (e.g., in the database server 36 of FIG. 1) for future processing.

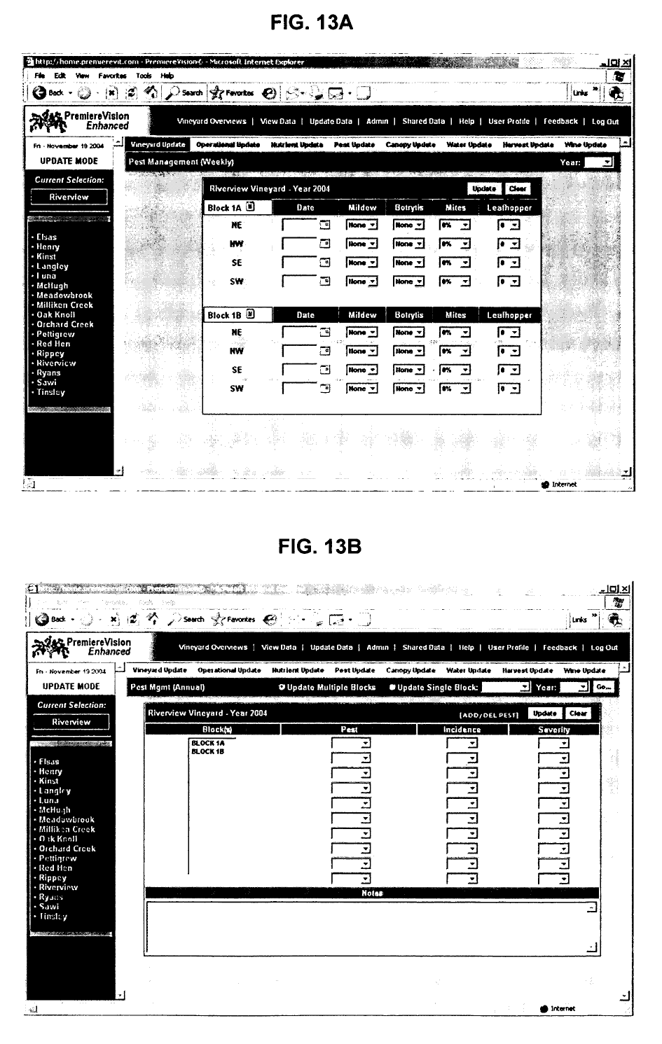

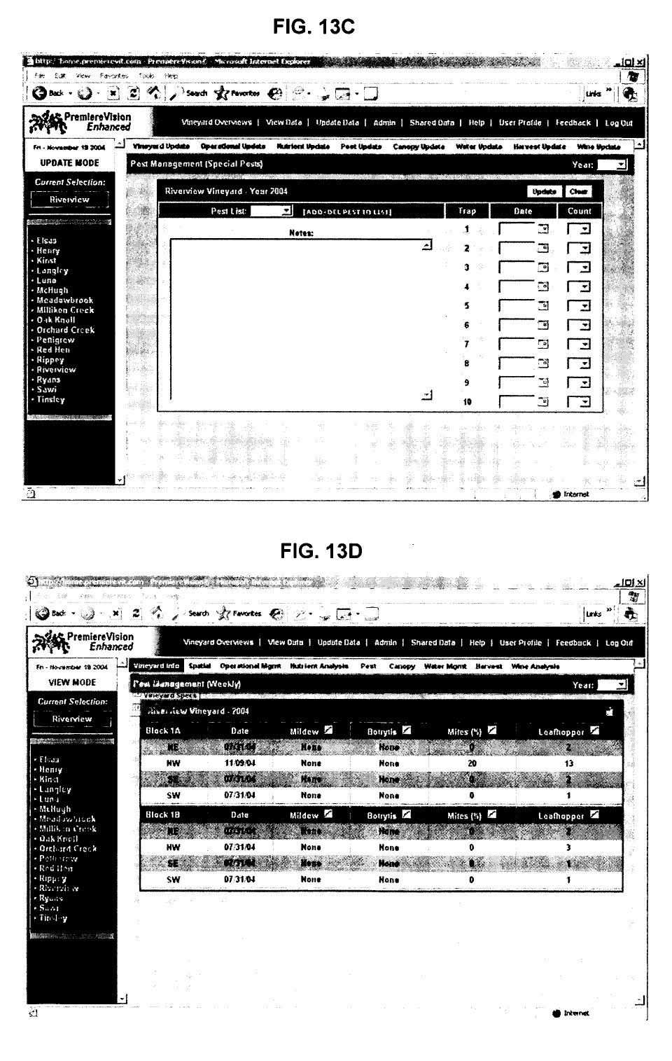

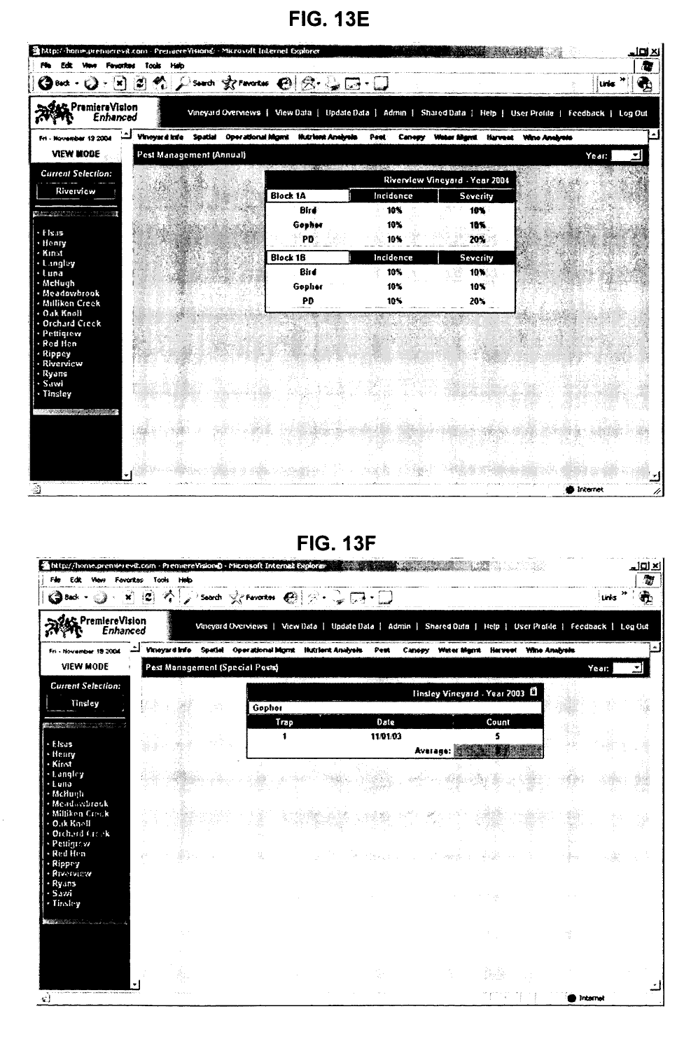

FIGS. 13A-13F are images showing user interface screens generated by the pest management module 120 of the present invention. Shown in FIG. 13A is the weekly pest management information page discussed earlier with respect to FIG. 12B, wherein weekly pest information can be defined by a user or a data source. Shown in FIG. 13B is the yearly pest management information page discussed earlier with respect to FIG. 12C, wherein yearly pest information can be defined by a user or a data source. Shown in FIG. 13C is the special pest management information page discussed earlier with respect to FIG. 12D, wherein special pest information can be defined by a user or a data source. FIGS. 13D-13F show pest management information displayed by the pest management module 120 in real time, wherein weekly, annual, and special pest information is provided, thereby allowing pest management decisions to be made at one or more vineyards in real time.

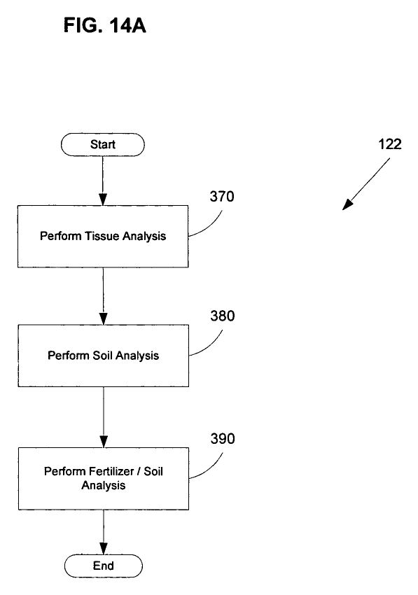

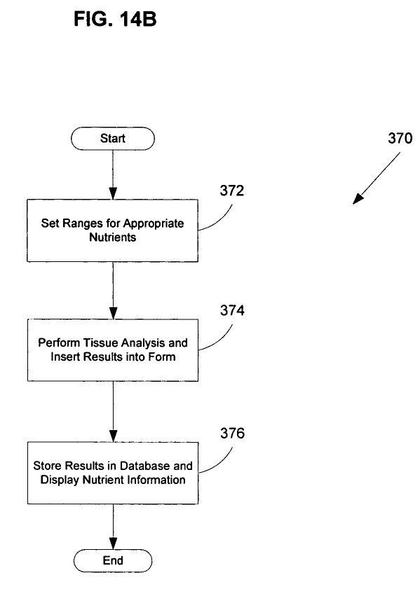

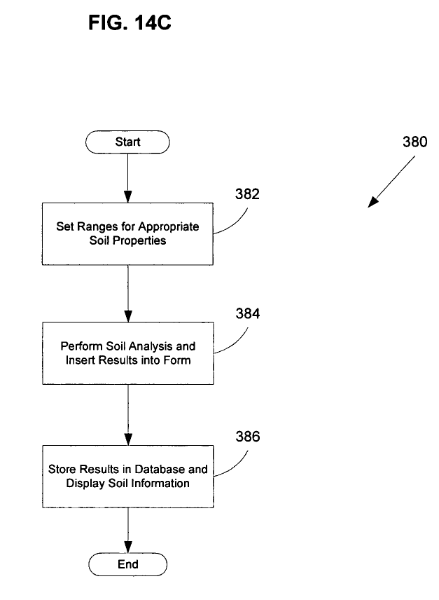

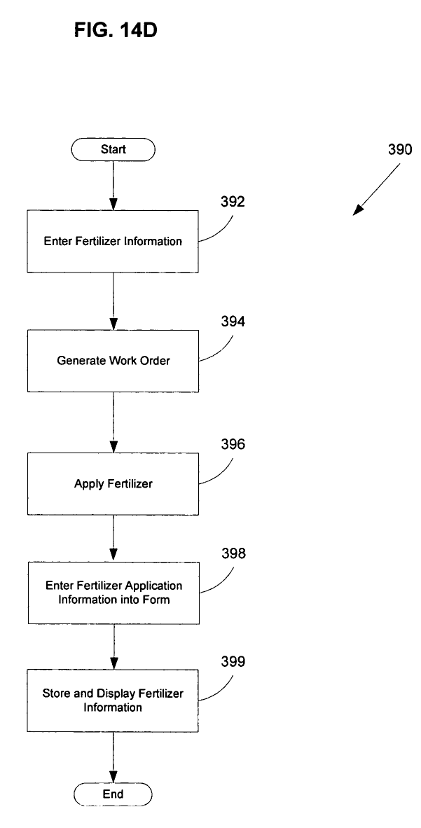

FIGS. 14A-14D are flowcharts showing processing logic of the nutritional analysis module 122 of the present invention. The nutritional analysis module 122 allows tissue, soil and fertilizer analysis to be performed at one or more vineyards. The overall processing steps of the module 122 are shown in FIG. 14A. Beginning in step 370, information about crop tissues (e.g., grape tissues, etc.) at one or more vineyards is collected, processed, and presented in real time for purchasing and management decisions. In step 380, information about soil at one or more vineyards is collected, processed, and presented in real time. In step 390, information about fertilizer at one or more vineyards is collected, processed, and presented in real time.

FIG. 14B shows the processing logic of step 370 of FIG. 14A in greater detail. In step 372, a form is provided for allowing a user or data source to enter range information for nutrients at one or more vineyards. The range information could include, but is not limited to, range definitions, current ranges, current values, and new values. Then, in step 374, a tissue analysis is performed on one or more samples of a crop at a vineyard, using known tissue analysis techniques. A form is then provided for allowing the user to enter tissue nutrient information provided by the tissue analysis, which could include, but is not limited to, contents of nutrients and/or vitamins such as NO₃, N, P, K, Zn, Mn, Na, B, Ca, Mg, Fe, Cu, S, Mo, or any other desired nutrient/vitamin. Once the nutrient information has been entered, in step 376 the results of nutrient analysis are processed and stored in a central database (such as the database server 36 of FIG. 1), and nutrient information is displayed in real time using a nutrient information page. The nutrient information page can automatically classify nutrient data as being deficient, low, optimum, high, or excessive based upon pre-defined parameters.

FIG. 14C shows the processing logic of step 380 of FIG. 14A in greater detail. In step 382, a form is provided for allowing a user or data source to enter range information for soil properties at one or more vineyards. The soil property range information could include, but is not limited to, range definitions, current low and high values, and new low and high values. Then, in step 384, a soil analysis is performed on one or more soil samples at a vineyard, using known soil analysis techniques. A form is then provided for allowing the user to enter soil information provided by the soil analysis, which could include, but is not limited to, boron content, calcium content, calcium percentage of Cation Exchange Capacity (CEC), calcium-to-magnesium ratio, chlorine, copper, exchangeable sodium percentage (ESP), iron content, potassium percentage of CEC, potassium-to-magnesium ratio, magnesium content, manganese content, magnesium percentage of CEC, sodium percentage of CEC, nitrate content, pH, or any other desire parameter. Additionally, the form could capture information about soluble cations, nutrients, ammonium acetate extractable cations, extractable cations, percentage rock, percentage sand, percentage silt, percentage clay, and textual class. Once the soil information has been entered, in step 386 the results of soil analysis are processed and stored in a central database (such as the database server 36 of FIG. 1), and soil information is displayed in real time using a soil information page. Further, the soil information page could automatically classify each of the soil parameters as low, optimum, or high based upon range information provided by a user or data source.

FIG. 14D shows the processing logic of step 390 of FIG. 14A in greater detail. In step 392, a form is provided for allowing a user or data source to fertilizer information for one or more vineyards. The fertilizer information could include, but is not limited to, block identifiers, application period, quantity per acre (in pounds or gallons), type of fertilizer applied, rationale for applying fertilizer, application method, and any desired notes. Then, in step 394, a fertilizer work order form could be provided for allowing a fertilizer work order to be generated for one or more vineyards. The work order could specify one or more blocks within a vineyard where fertilizer is to be applied, an application period, and special instructions. In step 396, fertilizer is applied to one or more blocks of one or more vineyards based upon the information provided in steps 392 and 394. In step 398, a form can be provided for allowing additional fertilizer application information to be provided. Once all fertilizer information has been entered, in step 399 the fertilizer information is processed and stored in a central database (such as the database server 36 of FIG. 1), and fertilizer information is displayed in real time using a fertilizer information page.

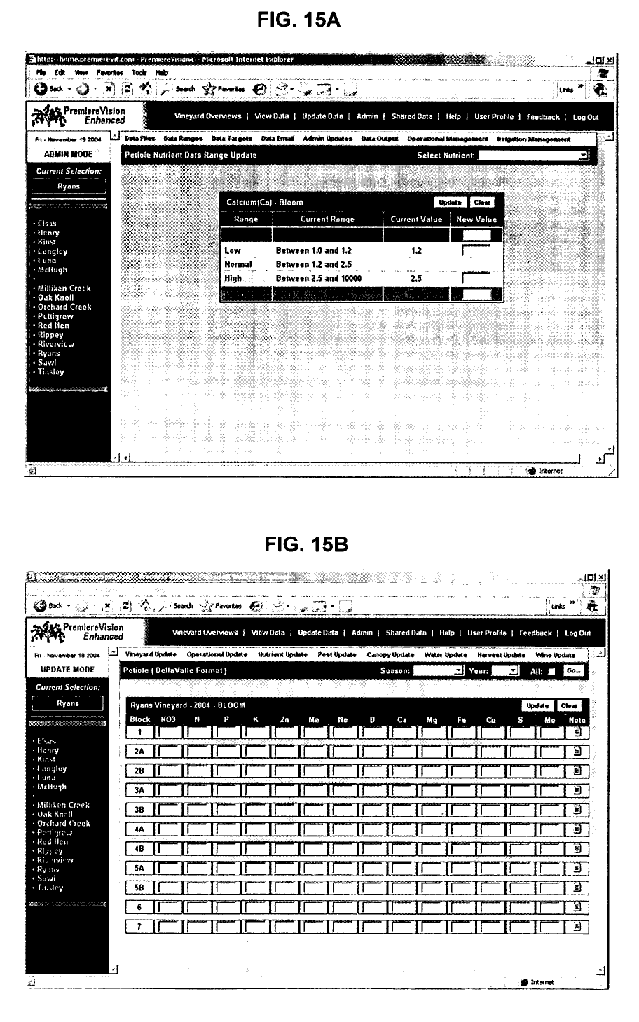

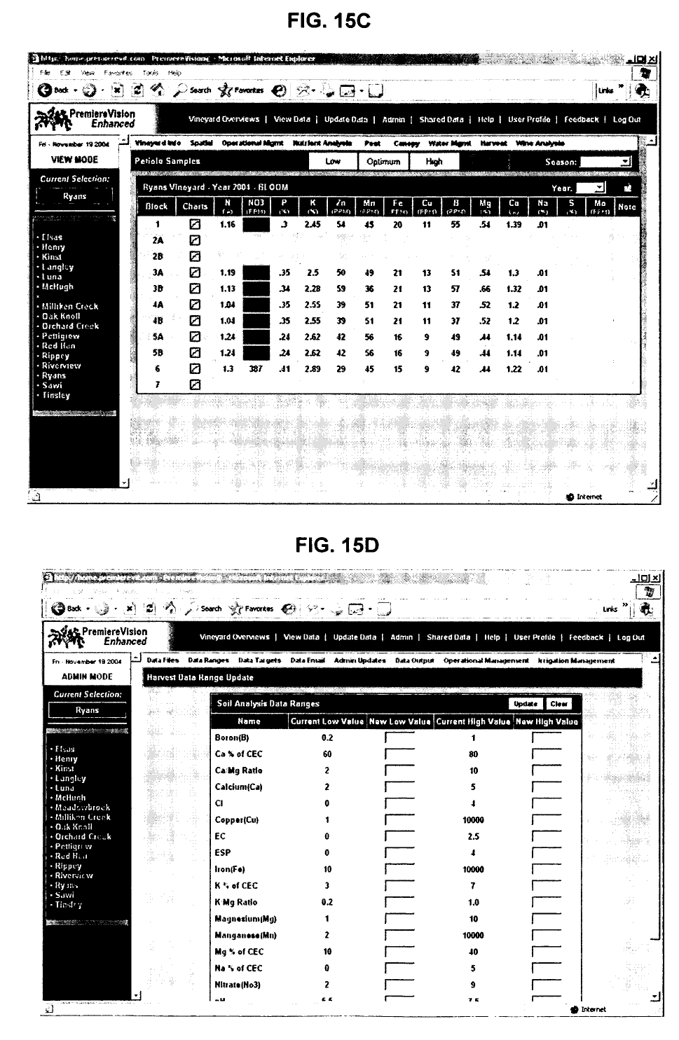

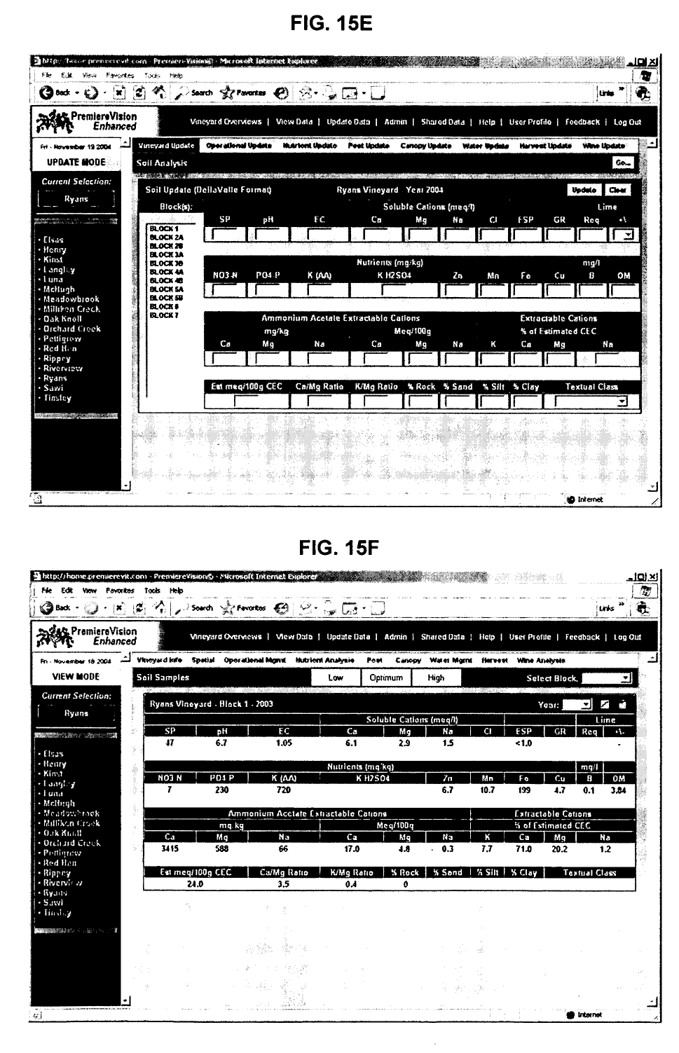

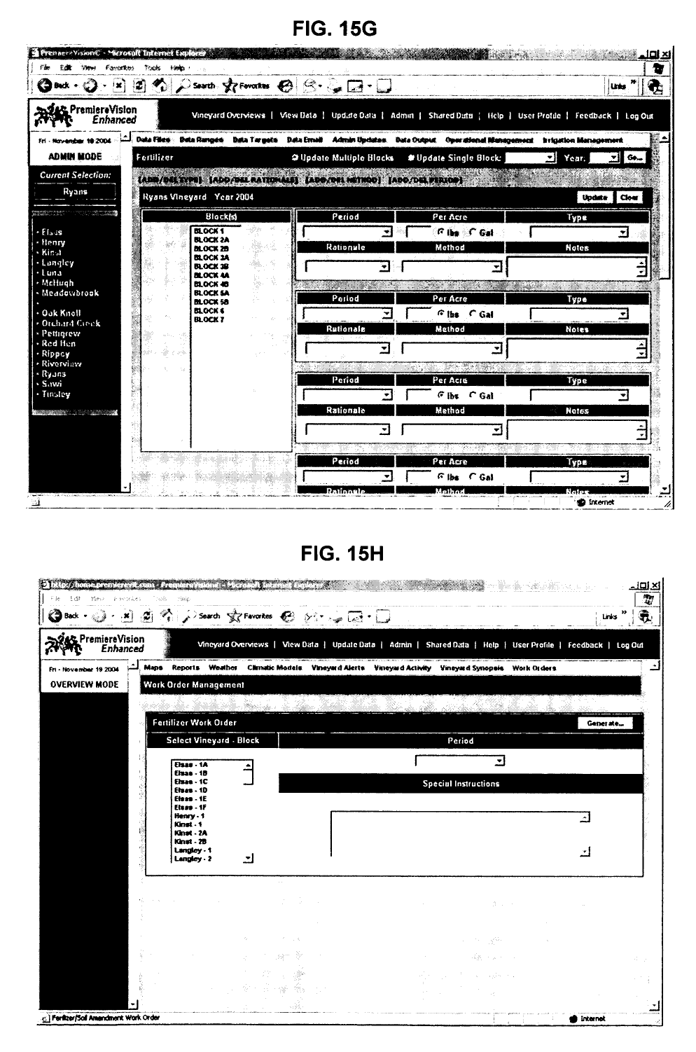

FIGS. 15A-15J are images showing user interface screens generated by the nutritional analysis module 122 of the present invention. Shown in FIGS. 15A-15B are forms according to the invention for allowing nutrient range data and tissue analysis information to be recorded. FIG. 15C shows the nutrient information page, wherein nutrient information is displayed in real time for one or more blocks of one or more vineyards. FIGS. 15D-15E are forms according to the invention for allowing soil ranges and information to be recorded. FIG. 15F shows the soil information page, wherein soil information is displayed in real time for one or more blocks of one or more vineyards. FIGS. 15G-15I are forms according to the present invention for allowing fertilizer ranges and information to be recorded. FIG. 15J shows the fertilizer information page, wherein fertilizer information is displayed in real time for one or more blocks of one or more vineyards. As can be readily appreciated, the nutritional analysis module of the present invention provides useful information about crop tissue, soil, and fertilizer parameters that can be accessed in real time to assist with vineyard planning and management.

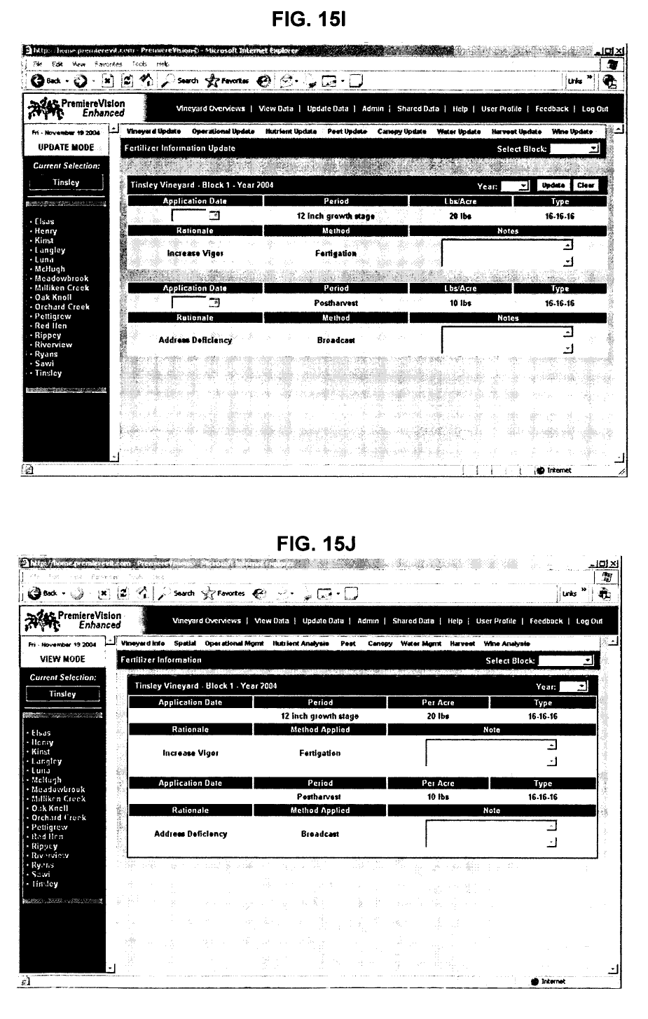

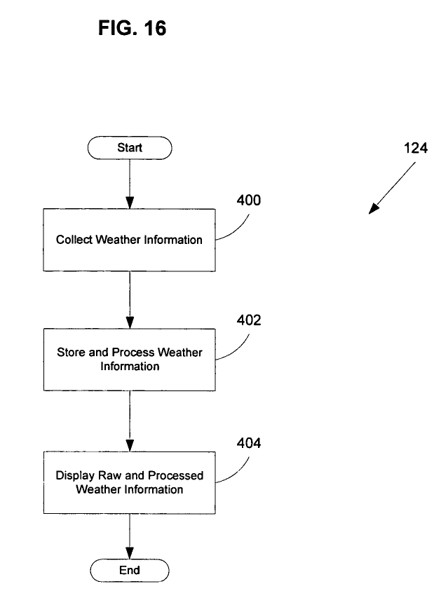

FIG. 16 is a flowchart showing processing logic of the weather module 124 of the present invention. The weather module 124 allows weather data at one or more vineyards to be collected, processed, and displayed in real time. Beginning in step 400, weather data is collected in real time for one or more vineyards. The weather data can be supplied from any suitable weather source, such as public weather station networks, remote sensing equipment, or through direct observation. In step 402, the weather information is stored in a central database (such as the database server 36 of FIG. 1) and processed. The weather data could include, but is not limited to, dates, precipitation, solar radiation, average vaporization, maximum air temperature, minimum air temperature, average air temperature, maximum relative humidity, minimum relative humidity, average relative humidity, dew points, average wind speeds, wind runs, and average soil temperatures. In step 404, the raw and processed data is displayed in real time in a weather information form accessible by a user or data source.

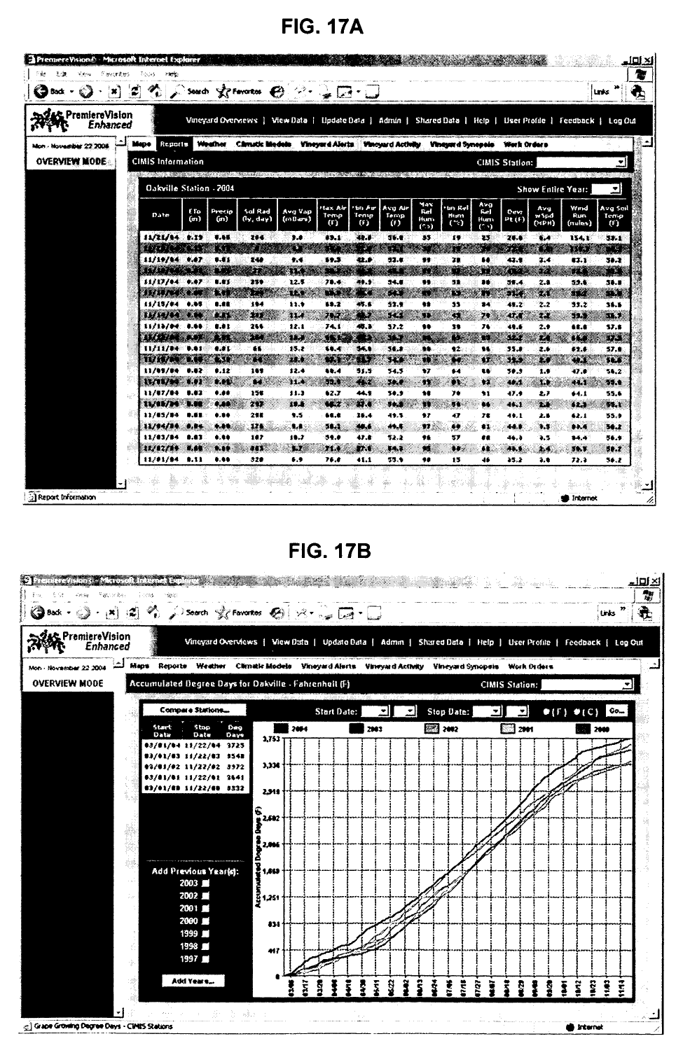

FIGS. 17A-17B are images showing user interface screens generated by the weather module 124 of the present invention. Shown in FIG. 17A is raw and processed weather information generated in real time by the weather module 124, presented in table format. Shown in FIG. 17B is a form for displaying accumulated degree days in chart form, wherein a plurality of years can be graphed for purposes of comparing years. A user can specify start and stop dates, as well as temperature units (degrees Fahrenheit or Celsius).

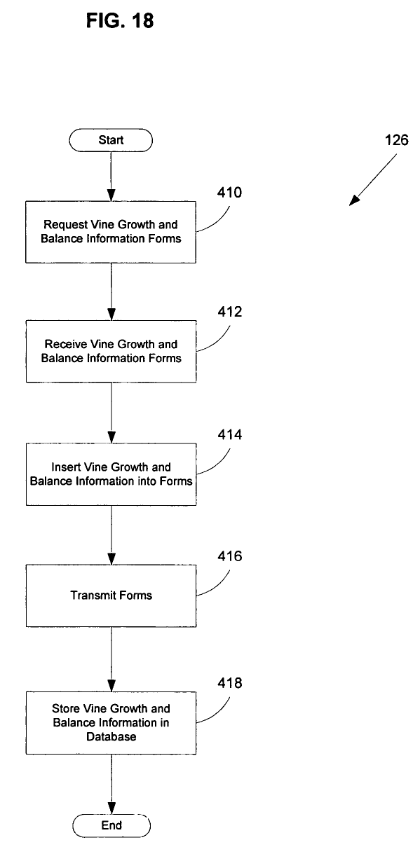

FIG. 18 is a flowchart showing processing logic of the canopy management module 126 of the present invention. The canopy management module 126 allows vine balance and growth information to be recorded for one or more vineyards using vine growth and balance information forms. The forms could comprise web pages accessible via the Internet and requested by a user or data source in step 410. In step 412, the forms are received by a data source or user, and in step 414, vine growth and balance information is entered. The vine growth and balance information could include, but is not limited to, block information, prune weights, cane counts, spur counts, node counts, shoot counts, test dates, tip scores, shoot lengths, node numbers, and any desired notes. Once the desired vine growth and balance information has been entered into the forms, in step 416 the forms are transmitted to the present invention. Thereafter, in step 418, the data in the forms is stored in a central database (e.g., in the database server 36 of FIG. 1) for future processing. Balance and growth status information pages can then be displayed, containing real-time vine growth and balance information.

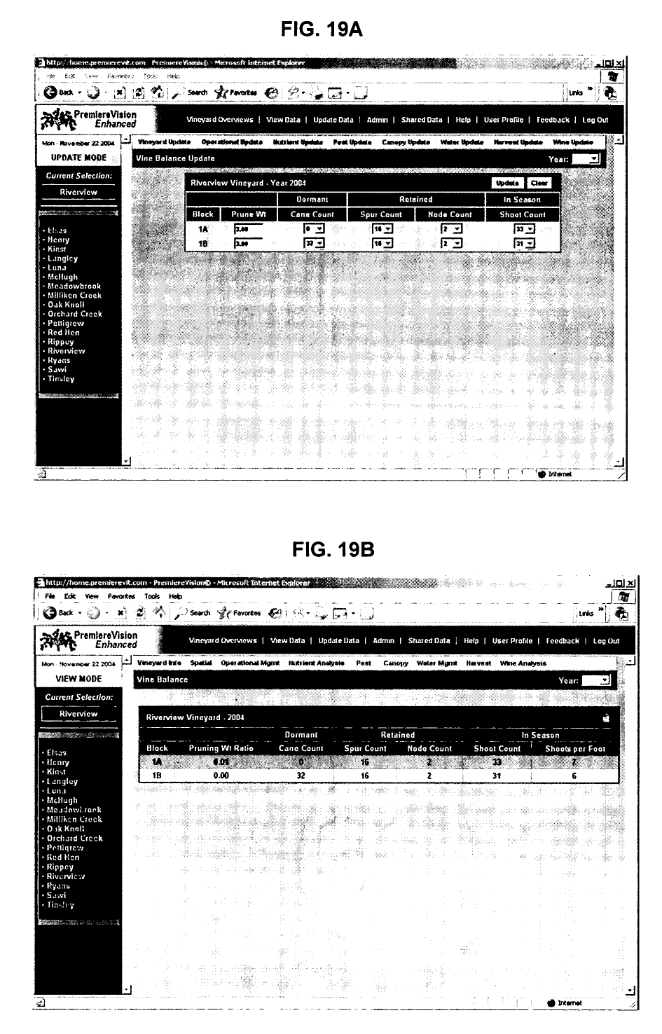

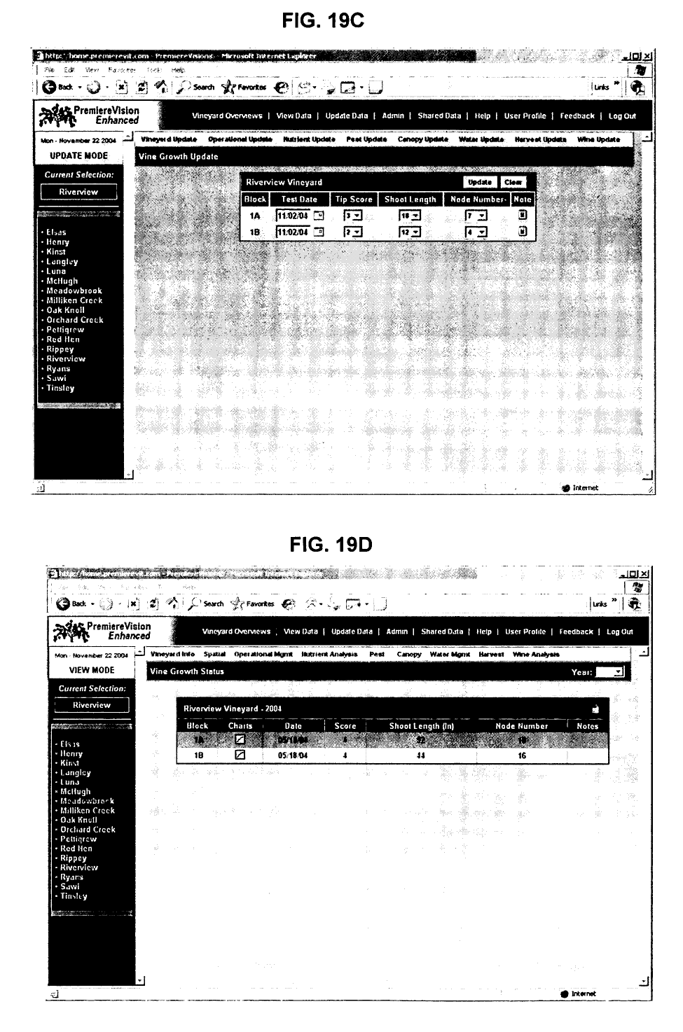

FIGS. 19A-19D are images showing user interface screens generated by the canopy management module 126 of the present invention. FIG. 19A shows a form generated by the present invention for allowing vine balance information to be entered for one or more vineyards. Stored and processed vine balance information can be displayed in real time via the vine balance information form shown in FIG. 19B. Vine growth information can be entered using the form shown in FIG. 19C, and monitored in real time using the page shown in FIG. 19D.

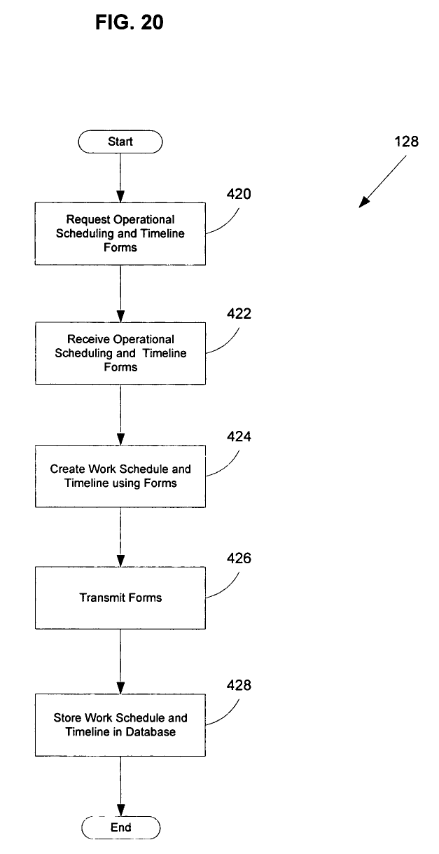

FIG. 20 is a flowchart showing processing logic of the operational scheduling/timeline module 128 of the present invention. The module 128 allows operational schedules and timelines to be generated for managing one or more vineyards. The forms could comprise web pages accessible via the Internet and requested by a user or data source in step 420. In step 422, the forms are received by a data source or user, and in step 424, work schedule and timeline information is entered using the forms. This information could include, but is not limited to, block information, year, activity description, start date, stop date, protocol information, work instructions, and fertilizing activity information. Once the information has been entered into the forms, in step 426 the forms are transmitted to the present invention. Thereafter, in step 428, the data in the forms is stored in a central database (e.g., in the database server 36 of FIG. 1) for future processing. Online schedules and timelines are then generated based upon the collected data, and can be accessed as desired over the Internet to manage vineyard operations.

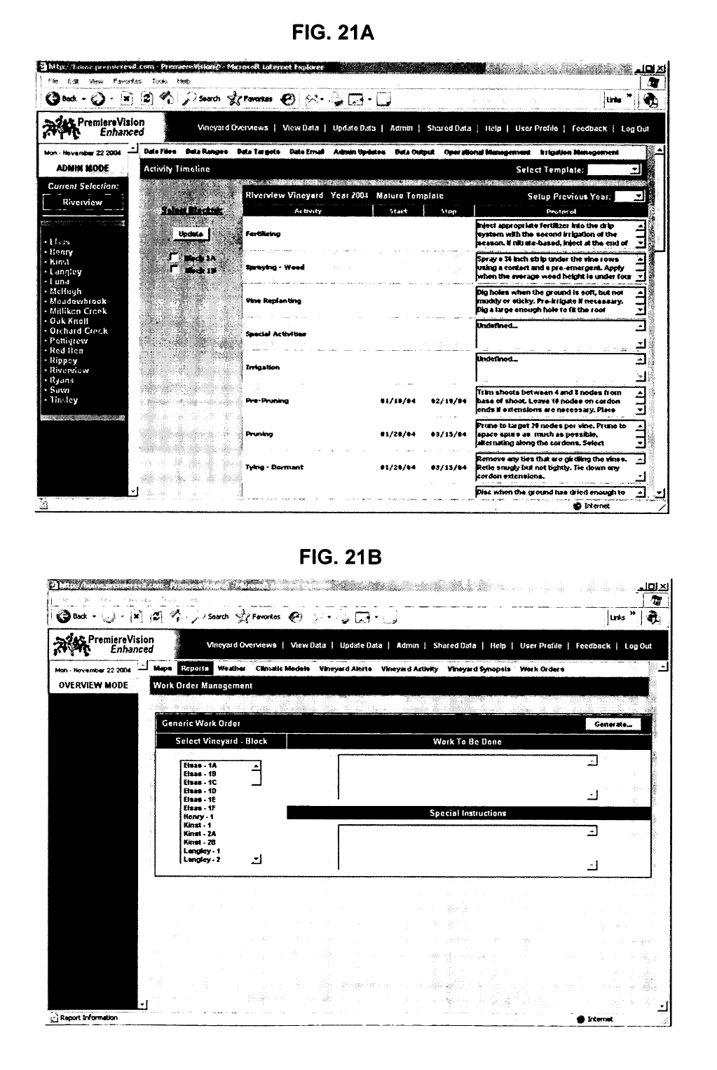

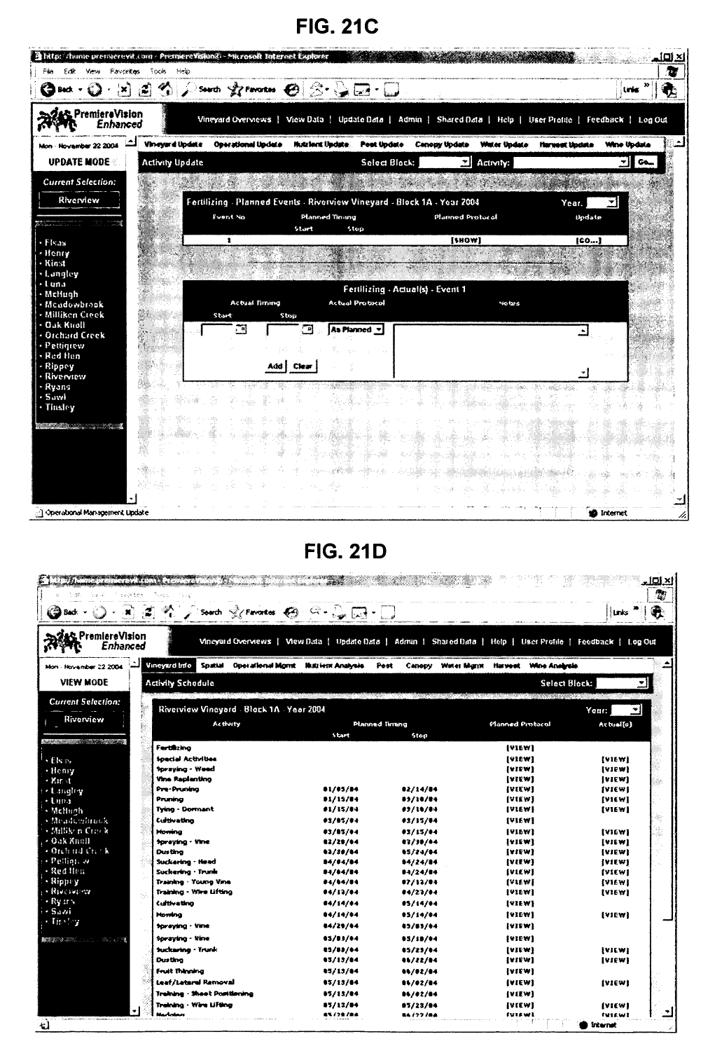

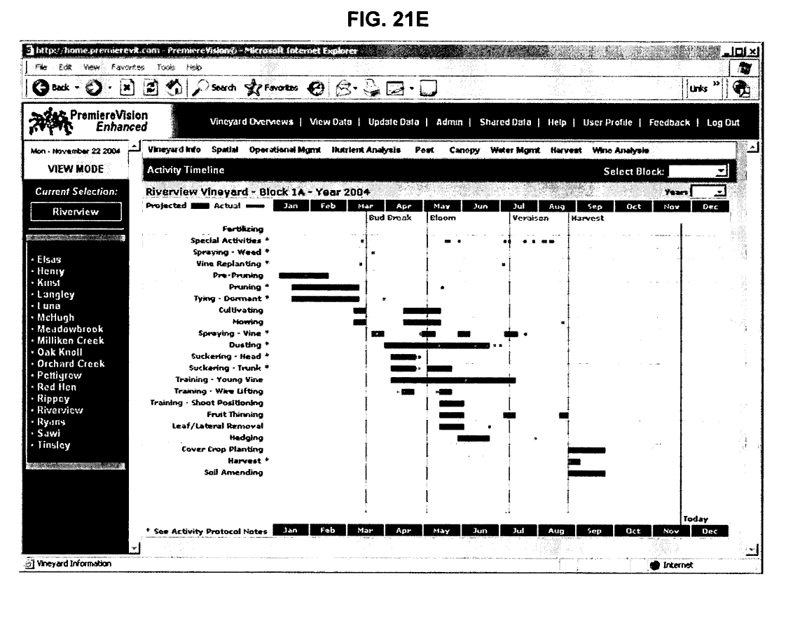

FIGS. 21A-21E are images showing user interface screens generated by the operational scheduling/timeline module 128 of the present invention. Shown in FIGS. 21A-21C are sample forms generated by the module 128 for allowing scheduling and timeline information to be collected from a user and/or data source. Based upon the collected data, activity schedules such as the schedule shown in FIG. 21D can be generated and accessed online for management purposes. Additionally, as shown in FIG. 21E, one or more activity timelines can be generated and accessed online.

In conclusion, the present invention provides a vineyard information collection and management system that allows for the collection, management, analysis, and reporting of vineyard information. Vineyard information can be collected from a virtually unlimited number of sources, such as remote computers, PDAs, third party sources, remote sensors, and other data sources. The system processes, analyzes, and reports collected information using convenient, easy-to-use forms and reports accessible anywhere via the Internet. The system is expandable to accommodate a user's requirements and to collect, manage, analyze, and report any desired type of vineyard information.

Having thus described the invention in detail, it is to be understood that the foregoing description is not intended to limit the spirit and scope thereof. What is desired to be protected by Letters Patent is set forth in the appended claims.

What is claimed is:

1. A vineyard information collection and management system comprising:
a central computing system for storing, processing, and analyzing real-time information about one or more vineyards;
a first remote computing system located at a data source;
a second remote computing system located at a remote user;
a network interconnecting the central computing system with the first and second remote computing systems;
a plurality of forms transmitted over the network to the first remote computing system for allowing the data source to enter the real-time information about the one or more vineyards, the real-time information transmitted to the central computing system; and
a plurality of reports produced by the central computing system and transmitted over the network to the second remote computing system, the reports summarizing the real-time information and including analyses of the real-time information to allow the remote user to make purchasing, operations, and management decisions about the one or more vineyards.

2. The system of claim 1, wherein the network comprises the Internet.

3. The system of claim 1, wherein the network comprises a wireless network.

4. The system of claim 1, wherein the first remote computing system comprises a handheld or laptop computer.

5. The system of claim 1, wherein the second remote computing system comprises a handheld or laptop computer.

6. The system of claim 1, further comprising a plurality of remote sensors located at the one or more vineyards for providing the real-time information.

7. The system of claim 1, wherein the central computing system further comprises a yield forecasting module for forecasting crop yields at the one or more vineyards.

8. The system of claim 7, wherein the real time information comprises block information including one or more of winery information, variety, rootstock, scion clone, year planted, row spacing, trellis type, row direction, soil texture, training information, emitter information, frost protection information, acreage, block name, rootstock source, scion source, year budded, vine spacing, row numbers, aspect information, grade percentage, number of wires, emitter rates, or foreman information.

9. The system of claim 7, wherein the real-time information comprises crop information including one or more of bunch counts, bunch weights, bunch gains, bunch losses, or harvest efficiency.

10. The system of claim 7, wherein the yield forecasting module produces a crop yield projection report including projected yields at the one or more vineyards.

11. The system of claim 1, wherein the central computing system comprises a harvest prediction module for predicting optimum harvest dates.

12. The system of claim 11, wherein the real-time information comprises brix information.

13. The system of claim 11, wherein the real-time information comprises harvest information including one or more of sample sizes, berry quantities, berry weights, cluster quantities, or cluster weights.

14. The system of claim 11, wherein the harvest prediction module produces a harvest report page including crop maturity and harvest date projections.

15. The system of claim 1, wherein the central computing system further comprises an irrigation scheduling module.

16. The system of claim 15, wherein the real-time information comprises irrigation parameters.

17. The system of claim 15, wherein the irrigation scheduling module calculates optimal irrigation times and durations and produces irrigation schedules.

18. The system of claim 1, wherein the central computing system further comprises an alert module for generating alerts based upon input data and pre-defined parameters.

19. The system of claim 1, wherein the central computing system further comprises a pest management module.

20. The system of claim 19, wherein the real-time information comprises weekly pest information including one or more of pest identifications, mildew values, botryis values, percentage of mites, or leafhopper information.

21. The system of claim 19, wherein the real-time information comprises annual pest information including one ore more of block information, pest information, year, number of incidences, and severity of incidences.

22. The system of claim 19, wherein the real-time information comprises special pest information including one or more of pest lists, trap identifiers, trap installation dates, or counts of trapped pests.

23. The system of claim 19, wherein the pest management module produces weekly, annual, and special pest reports.

24. The system of claim 1, wherein the central computing system comprises a nutritional analysis module.

25. The system of claim 24, wherein the real-time information comprises one or more of tissue, soil, or nutrient analysis information.

26. The system of claim 25, wherein the nutritional analysis module processes the tissue, soil, and nutrient analysis information and produces tissue, soil, and nutrient reports.

27. The system of claim 26, wherein the tissue, soil, and nutrient reports automatically identify deficient, low, optimum, high, and excessive tissue, soil, or nutrient values.

28. The system of claim 1, wherein the central computing system further comprises a weather module.

29. The system of claim 28, wherein the weather module processes real-time weather information corresponding to one or more vineyards.

30. The system of claim 29, wherein the weather module produces a weather report containing real-time weather information about the one or more vineyards.

31. The system of claim 1, wherein the central computing system further comprises a canopy management module.

32. The system of claim 21, wherein the real-time information further comprises vine growth and balance information including one or more of prune weights, prune weight ratios, cane counts, spur counts, node counts, shoot counts, test dates, tip scores, and number of shoots per foot.

33. The system of claim 21, wherein the canopy management module produces vine growth and balance reports.

34. The system of claim 1, wherein the central computing system further comprises an operational scheduling module.

35. The system of claim 34, wherein the operational scheduling module prepares work schedule and timelines for tasks to be completed at one or more vineyards.

36. A method for managing information about one or more vineyards comprising:
providing a central computing system for storing, processing, and analyzing real-time information about one or more vineyards;
providing a first remote computing system located at a data source;
providing a second remote computing system located at a remote user;
interconnecting the central computing system and the first and second remote computing systems with a network;
transmitting at least one form over the network to the first remote computing system;
allowing the data source to enter information about a vineyard using the at least one form;
storing, processing, and analyzing the information at the central computing system; and
producing a report summarizing and analyzing the information to assist in making purchasing, operations, and management decisions about the vineyard, the report accessible by the user at the second remote computing system.

37. The method of claim 36, further comprising receiving information at the central computing system from one or more remote sensors located at the vineyard.

38. The method of claim 36, further comprising forecasting crop yields at the central computing system using the information.

39. The method of claim 38, wherein the step of producing the report comprises producing a crop yield report containing projected crop yields forecasted by the central computing system.

40. The method of claim 36, further comprising calculating grape maturities and optimal harvest dates using the information.

41. The method of claim 40, further comprising producing the report comprises producing a grape maturity report containing grape maturity information and optimal harvest dates calculated by the central computing system.

42. The method of claim 36, wherein the step of allowing the data source to enter information comprises allowing the data source to specify irrigation parameters for the vineyard using the at least one form.

43. The method of claim 42, further comprising producing an irrigation schedule using the irrigation parameters.

44. The method of claim 36, wherein the step of allowing the data source to enter information comprises allowing the data source to specify alert ranges using the at least one form.

45. The method of claim 44, further comprising monitoring information at the central computing system using the alert ranges.

46. The method of claim 45, wherein the step of producing the report comprises generating one or more alert reports at the central computing system and transmitting the alert reports to the remote user.

47. The method of claim 36, wherein the step of allowing the data source to enter information comprises allowing the data source to specify pest information about the one or more vineyards using the at least one form.

48. The method of claim 47, wherein the step of producing the report comprise producing a pest report using the pest information.

49. The method of claim 36, wherein the step of allowing the data source to enter information comprises allowing the data source to enter tissue, soil, and nutrient information using the at least one form.

50. The method of claim 49, wherein the step of producing the report comprises producing tissue, soil, and nutrient reports using the tissue, soil, and nutrient information.

51. The method of claim 36, further comprising receiving real-time weather information at the central computing system.

52. The method of claim 51, wherein the step of producing the report comprises producing a weather report using the real-time weather information.

53. The method of claim 36, wherein the step of allowing the data source to enter information comprises allowing the data source to vine growth and balance information using the at least one form.

54. The method of claim 53, wherein the step of producing the report comprises producing vine growth and balance reports using the vine growth and balance information.

55. The method of claim 36, further comprising preparing work schedules and timelines for one or more vineyards.

56. A method for allowing a winery to acquire and manage information at a vineyard comprising:
providing a central computer system for storing, processing, and analyzing real-time information about one or more vineyards;
providing a data source with a portable computer system;
allowing the data source to travel to the one or more vineyards;
allowing the data source to enter real-time information into one or more forms on the portable computer system about the one or more vineyards;
transmitting the information to the central computing system;
storing and processing the information at the central computing system;
providing one or more wineries with one or more reports containing real-time information about the one or more vineyards; and
allowing the one or more wineries to make purchasing decisions about the one or more vineyards using the real-time information in the one or more reports.

57. The method of claim 56, wherein the step of storing and processing the information at the central computing system comprises storing and processing crop yield information to produce yield forecasts.

58. The method of claim 57, wherein the step of providing the one or more reports comprises providing a report containing the yield forecasts.

59. The method of claim 56, wherein the step of storing and processing the information at the central computing system comprises storing and processing crop maturity information to produce harvest date forecasts.

60. The method of claim 59, wherein the step of providing the one or more reports comprises providing a report containing the harvest date forecasts.

61. The method of claim 56, wherein the step of storing and processing the information at the central computing system comprises storing and processing irrigation information to produce one or more irrigation schedules.

62. The method of claim 61, wherein the step of providing the one or more reports comprises providing a report containing the one or more irrigation schedules.

63. The method of claim 56, wherein the step of storing and processing the information at the central computing system comprises storing and processing user-defined alert information and monitoring input data in accordance with the alert information.

64. The method of claim 63, wherein the step of providing the one or more reports comprises providing a report containing one or more alerts.

65. The method of claim 56, wherein the step of storing and processing the information at the central computing system comprises storing and processing pest information.

66. The method of claim 65, wherein the step of providing the one or more reports comprises providing a report containing a summary of pests at the one or more vineyards.

67. The method of claim 56, wherein the step of storing and processing the information at the central computing system comprises storing and processing nutritional information.

68. The method of claim 67, wherein the step of providing the one or more reports comprises providing a report containing crop nutrition information.

69. The method of claim 56, wherein the step of storing and processing the information at the central computing system comprises storing and processing weather information for the one or more vineyards.

70. The method of claim 69, wherein the step of providing the one or more reports comprises providing a report containing a summary of weather information at the one or more vineyards.

71. The method of claim 56, wherein the step of storing and processing the information at the central computing system comprises storing and processing canopy information.

72. The method of claim 71, wherein the step of providing the one or more reports comprises providing a report containing a summary of canopy information at the one or more vineyards.

73. The method of claim 56, further comprising allowing the one or more wineries to produce operational schedules and timelines using the central computing system.
